(19) United States
(12) Patent Application Publication
(10) Pub. No.: US 2022/0284632 A1
(43) Pub. Date: Sep. 8, 2022

(54) ANALYSIS DEVICE AND COMPUTER-READABLE RECORDING MEDIUM STORING ANALYSIS PROGRAM

(71) Applicant: FUJITSU LIMITED, Kawasaki-shi (JP)

(72) Inventors: Tomonori KUBOTA, Kawasaki (JP); Takanori Nakao, Kawasaki (JP); Yasuyuki Murata, Shizuoka (JP)

(73) Assignee: FUJITSU LIMITED, Kawasaki-shi (JP)

(21) Appl. No.: 17/751,871

(22) Filed: May 24, 2022

Related U.S. Application Data
(63) Continuation of application No. PCT/JP2019/050896, filed on Dec. 25, 2019.

(51) Int. Cl. G06T 9/00; G06V 10/70

(52) U.S. Cl. CPC G06T 9/00; G06V 10/70

(57) ABSTRACT

An analysis device includes: a memory; and a computer coupled to the memory and configured to: store information that indicates a degree of influence of each area of each piece of decoded data on recognition results and is calculated by performing a recognition process on the decoded data obtained by decoding each piece of compressed data when a compression process is performed on image data at different compression levels; and designate the compression levels for each area of the image data, based on the information that corresponds to the different compression levels and indicates the degree of influence of each area of each piece of the decoded data on the recognition results.

### CROSS-REFERENCE TO RELATED APPLICATION

This application is a continuation application of International Application PCT/JP2019/050896 filed on Dec. 25, 2019 and designated the U.S., the entire contents of which are incorporated herein by reference.

### FIELD

The embodiments discussed herein are related to an analysis device and an analysis program.

### BACKGROUND

Commonly, when image data is recorded or transmitted, the reduction of the recording cost and transmission cost is achieved by making the data size smaller by an image compression process.

Japanese Laid-open Patent Publication No. 2018-101406, Japanese Laid-open Patent Publication No. 2019-079445, and Japanese Laid-open Patent Publication No. 2011-234033 are disclosed as related art.

### SUMMARY

According to an aspect of the embodiments, an analysis device includes: a memory; and a computer coupled to the memory and configured to: store information that indicates a degree of influence of each area of each piece of decoded data on recognition results and is calculated by performing a recognition process on the decoded data obtained by decoding each piece of compressed data when a compression process is performed on image data at different compression levels; and designate the compression levels for each area of the image data, based on the information that corresponds to the different compression levels and indicates the degree of influence of each area of each piece of the decoded data on the recognition results.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an example of the system configuration of a compression processing system;

FIG. 2 is a diagram illustrating an example of the hardware configuration of an analysis device or an image compression device;

FIG. 3 is a first diagram illustrating an example of the functional configuration of the analysis device;

FIG. 4 is a diagram illustrating a specific example of an aggregation result;

FIG. 5 is a first diagram illustrating a specific example of processing by a quantization value designation unit;

FIG. 6 is a first diagram illustrating an example of the functional configuration of the image compression device;

FIG. 7 is a first flowchart illustrating an example of the flow of an image compression process by the compression processing system;

FIG. 8 is a second diagram illustrating an example of the functional configuration of an analysis device;

FIG. 9 is a second diagram illustrating a specific example of processing by a quantization value designation unit;

FIG. 10 is a second flowchart illustrating an example of the flow of an image compression process by a compression processing system;

FIG. 11 is a third diagram illustrating an example of the functional configuration of an analysis device;

FIG. 12 is a third diagram illustrating a specific example of processing by a quantization value designation unit;

FIG. 13 is a third flowchart illustrating an example of the flow of an image compression process by a compression processing system;

FIG. 14 is a fourth diagram illustrating an example of the functional configuration of an analysis device;

FIG. 15 is a diagram illustrating a specific example of processing by a quantization value setting unit;

FIG. 16 is a fourth flowchart illustrating an example of the flow of an image compression process by a compression processing system;

FIG. 17 is a fourth diagram illustrating a specific example of processing by a quantization value designation unit;

FIG. 18 is a fifth flowchart illustrating an example of the flow of an image compression process by a compression processing system;

FIG. 19 is a fifth diagram illustrating a specific example of processing by a quantization value designation unit;

FIG. 20 is a sixth flowchart illustrating an example of the flow of an image compression process by a compression processing system;

FIG. 21 is a fifth diagram illustrating an example of the functional configuration of an analysis device;

FIG. 22 is a diagram illustrating a specific example of processing by an invalid area determination unit;

FIG. 23 is a diagram illustrating a specific example of invalidated image data;

FIG. 24 is a seventh flowchart illustrating an example of the flow of an image compression process by a compression processing system;

FIG. 25 is a sixth diagram illustrating an example of the functional configuration of an analysis device;

FIG. 26 is a diagram illustrating a specific example of processing by an effective area determination unit;

FIGS. 27A and 27B are an eighth flowchart illustrating an example of the flow of an image compression process by a compression processing system;

FIG. 28 is a seventh diagram illustrating an example of the functional configuration of an analysis device;

FIG. 29 is a second diagram illustrating a specific example of processing by an effective area determination unit; and

FIG. 30 is a ninth flowchart illustrating an example of the flow of an image compression process by a compression processing system.

### DESCRIPTION OF EMBODIMENTS

Meanwhile, in recent years, there have been an increasing number of cases in which image data is recorded or transmitted for the purpose of being utilized for an image recognition process by artificial intelligence (AI). As a representative model of AI, for example, a model using deep learning or machine learning can be cited.

However, the past compression processing is performed based on the human visual characteristics and thus is not performed based on the motion analysis of AI. For this reason, there have been cases where the compression process is not performed at a sufficient compression level for the area that is not involved in the image recognition process by AI.

In one aspect, an object is to implement a compression process suitable for an image recognition process by AI.

Hereinafter, each embodiment will be described with reference to the accompanying drawings. Note that, in the present specification and the drawings, constituent elements having substantially the same functional configuration are denoted by the same reference sign, and redundant description will be omitted.

### First Embodiment

### <System Configuration of Compression Processing System>

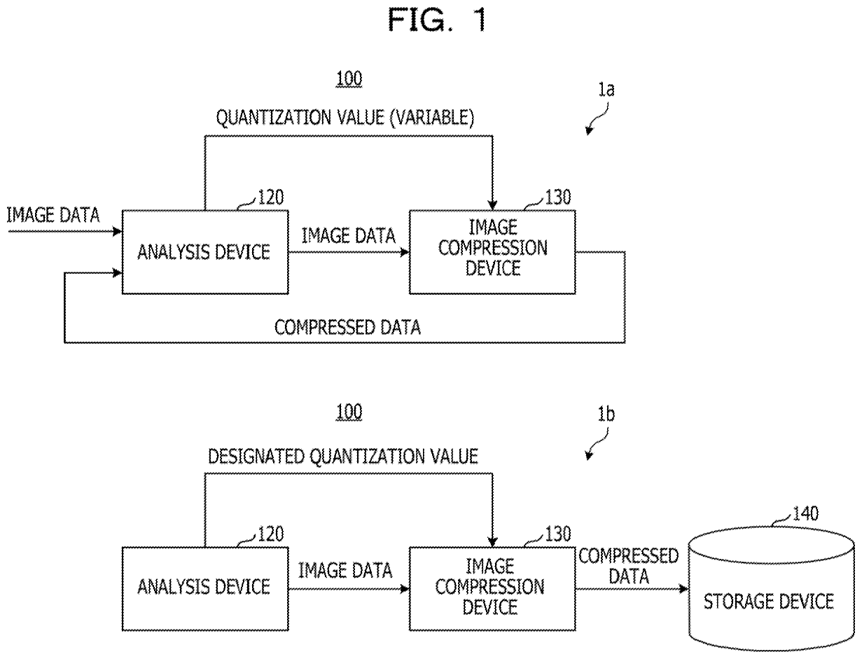

First, a system configuration of the entire compression processing system including an analysis device according to a first embodiment will be described. FIG. 1 is a first diagram illustrating an example of the system configuration of the compression processing system. In the first embodiment, the processing executed by the compression processing system can be roughly divided into a phase of designating a compression level (quantization value) and a phase of performing a compression process based on the designated compression level (quantization value).

In FIG. 1, a system configuration of the compression processing system in the phase of designating the compression level (quantization value) is indicated by 1a, and a system configuration of the compression processing system in the phase of performing the compression process based on the designated compression level (quantization value) is indicated by 1b.

As illustrated in 1a of FIG. 1, the compression processing system in the phase of designating the compression level (quantization value) includes an imaging device 110, an analysis device 120, and an image compression device 130.

The imaging device 110 captures an image at a predetermined frame period and transmits image data to the analysis device 120. Note that the image data includes an object targeted for a recognition process.

The analysis device 120 includes a learned model that performs the recognition process and performs the recognition process by inputting image data or decoded data obtained by decoding compressed data when the compression process is performed on the image data at different compression levels to the learned model, to output the recognition result.

In addition, the analysis device 120 generates a map (referred to as an important feature map) indicating the degree of influence on the recognition result, by performing motion analysis for the learned model using, for example, an error back propagation method and aggregates the degree of influence for each predetermined area (for each block used when the compression process is performed).

Note that the analysis device 120 instructs the image compression device 130 to perform the compression process at different compression levels (quantization values) and repeats similar processes on each piece of the compressed data when the compression process is performed at each compression level.

The analysis device 120 calculates an aggregated value of the degree of influence of each block each time the image compression device 130 is instructed to perform the compression process at different compression levels and designates an optimum compression level (quantization value) of each block, based on changes in the aggregated value with respect to each compression level (each quantization value). Note that the optimum compression level (quantization value) refers to the maximum compression level (quantization value) that allows the recognition process to be precisely performed on the object included in the image data.

In this manner, according to the analysis device 120, by performing the motion analysis on the learned model and calculating the degree of influence on the recognition result, the optimum compression level for when the compression process suitable for the image recognition process by the learned model is performed may be designated.

Meanwhile, as illustrated in 1b of FIG. 1, the compression processing system in the phase of performing the compression process based on the designated compression level (quantization value) includes the analysis device 120, the image compression device 130, and a storage device 140.

The analysis device 120 transmits the optimum compression levels (quantization values) designated for each block and the image data to the image compression device 130.

The image compression device 130 performs the compression process on the image data, using the designated optimum compression levels (quantization values) and stores the compressed data in the storage device 140.

In this manner, the analysis device 120 according to the present embodiment uses a compression level suitable for the image recognition process by the learned model. For example, the analysis device 120 according to the present embodiment has the following differences from the past compression process and therefore, is allowed to implement the compression process suitable for the image recognition process by the learned model.

Originally, the past compression process is not based on a feature part focused at the time of inference (it is merely based on the shape, properties, targets of interest, and the like that can be grasped by the human concept), and the feature part focused at the time of inference (a feature part that is not usually allowed to be demarcated by boundaries in the human concept) is not used.

In the past compression process, the internal motion of a convolutional neural network (CNN) unit 320, which is a course of outputting the recognition result (for example, the signal and processing result propagation course from the input of the image data to the output of the recognition result, and the propagation intensity of the signal and processing result), is not analyzed.

### <Hardware Configuration of Analysis Device or Image Compression Device>

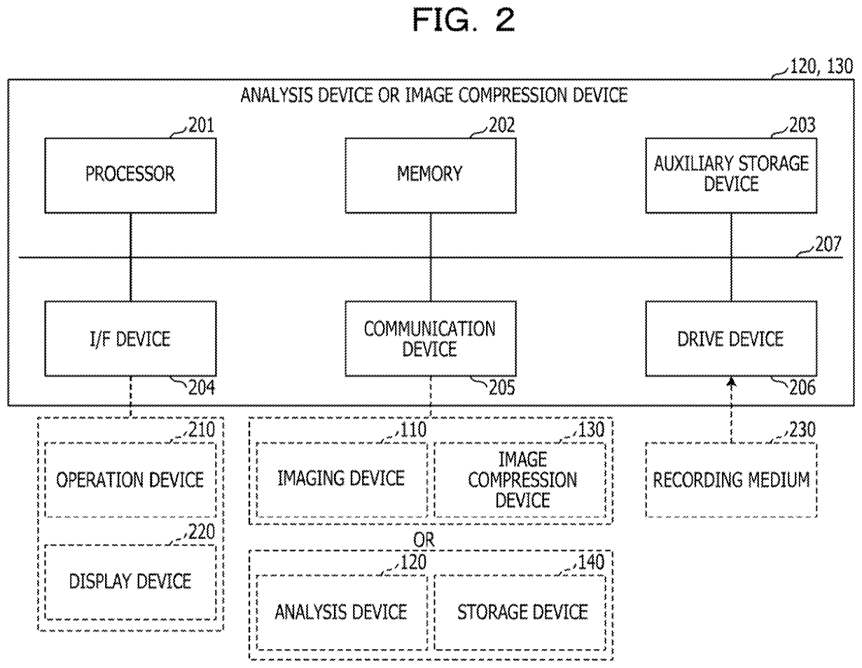

Next, a hardware configuration of the analysis device 120 and the image compression device 130 will be described. Note that, since the analysis device 120 and the image compression device 130 have similar hardware configurations, both the devices will be collectively described here with reference to FIG. 2.

FIG. 2 is a diagram illustrating an example of the hardware configuration of the analysis device or the image compression device. The analysis device 120 or the image compression device 130 includes a processor 201, a memory 202, an auxiliary storage device 203, an interface (I/F) device 204, a communication device 205, and a drive device 206. Note that the respective pieces of hardware of the analysis device 120 or the image compression device 130 are interconnected via a bus 207.

The processor 201 includes various arithmetic devices such as a central processing unit (CPU) and a graphics processing unit (GPU). The processor 201 reads various programs (for example, an analysis program or an image compression program or the like described later) into the memory 202 and executes the read programs.

The memory 202 includes a main storage device such as a read only memory (ROM) or a random access memory (RAM). The processor 201 and the memory 202 form a so-called computer. The processor 201 executes various programs read into the memory 202 to cause the computer to implement various functions (details of the various functions will be described later).

The auxiliary storage device 203 stores various programs and various pieces of data used when the various programs are executed by the processor 201.

The I/F device 204 is a connection device that connects an operation device 210 and a display device 220, which are examples of external devices, with the analysis device 120 or the image compression device 130. The I/F device 204 receives an operation for the analysis device 120 or the image compression device 130 via the operation device 210. In addition, the I/F device 204 outputs a result of processing by the analysis device 120 or the image compression device 130 and displays the result via the display device 220.

The communication device 205 is a communication device for communicating with another device. In the case of the analysis device 120, communication is performed with the imaging device 110 and the image compression device 130 via the communication device 205. In addition, in the case of the image compression device 130, communication is performed with the analysis device 120 and the storage device 140 via the communication device 205.

The drive device 206 is a device for setting a recording medium 230. The recording medium 230 mentioned here includes a medium that optically, electrically, or magnetically records information, such as a compact disc read only memory (CD-ROM), a flexible disk, or a magneto-optical disk. Alternatively, the recording medium 230 may include a semiconductor memory or the like that electrically records information, such as a ROM or a flash memory.

Note that various programs installed in the auxiliary storage device 203 are installed, for example, by setting the distributed recording medium 230 in the drive device 206 and reading the various programs recorded in the recording medium 230 by the drive device 206. Alternatively, the various programs to be installed in the auxiliary storage device 203 may be installed by being downloaded from a network via the communication device 205.

### <Functional Configuration of Analysis Device>

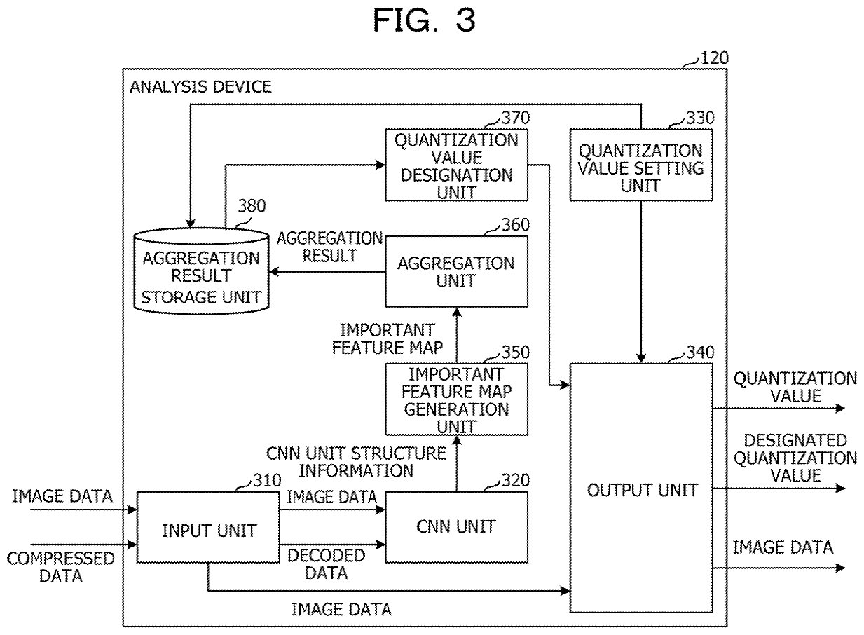

Next, a functional configuration of the analysis device 120 will be described. FIG. 3 is a first diagram illustrating an example of the functional configuration of the analysis device. As described above, the analysis program is installed in the analysis device 120, and when the program is executed, the analysis device 120 functions as an input unit 310, a CNN unit 320, a quantization value setting unit 330, and an output unit 340. In addition, the analysis device 120 functions as an important feature map generation unit 350, an aggregation unit 360, and a quantization value designation unit 370.

The input unit 310 acquires image data transmitted from the imaging device 110 or compressed data transmitted from the image compression device 130. The input unit 310 notifies the CNN unit 320 and the output unit 340 of the acquired image data and decodes the acquired compressed data using a decoding unit (not illustrated) to also notify the CNN unit 320 of the decoded data.

The CNN unit 320 includes a learned model and, by inputting the image data or the decoded data, performs the recognition process on an object included in the image data or the decoded data to output the recognition result.

The quantization value setting unit 330 notifies the output unit 340 sequentially of the compression levels (from the minimum quantization value (initial value) to the maximum quantization value) used when the image compression device 130 performs the compression process and also stores the compression levels in an aggregation result storage unit 380, which is an example of a storage unit.

The output unit 340 transmits the image data acquired by the input unit 310 to the image compression device 130. In addition, each quantization value notified by the quantization value setting unit 330 is sequentially transmitted to the image compression device 130. Furthermore, the quantization value (designated quantization value) designated by the quantization value designation unit 370 is transmitted to the image compression device 130.

The important feature map generation unit 350 is an example of a map generation unit and acquires CNN unit structure information when the learned model performed the recognition process on the image data or the decoded data, to generate an important feature map by utilizing an error back propagation method based on the acquired CNN unit structure information.

The important feature map generation unit 350 generates the important feature map by using, for example, a back propagation (BP) method, a guided back propagation (GBP) method, or a selective BP method.

Note that the BP method is a method in which the error of each label is computed from a classification probability obtained by performing the recognition process on image data (or decoded data) whose recognition result is the correct answer label, and the feature part is visualized by forming an image of the magnitude of a gradient obtained by back propagation to the input layer. In addition, the GBP method is a method in which the feature part is visualized by forming an image of only the positive values of the gradient information as the feature part.

Furthermore, the selective BP method is a method in which back propagation is performed using the BP method or the GBP method after maximizing only the errors of the correct answer labels. In the case of the selective BP method, the feature part to be visualized is a feature part that affects only the scores of the correct answer labels.

In this manner, by using the BP method, the GBP method, or the selective BP method, the important feature map generation unit 350 analyzes the signal flow and intensity of each path in the CNN unit 320 from the input of the image data or the decoded data to the output of the recognition result. Consequently, according to the important feature map generation unit 350, it may be possible to visualize which part of the input image data or decoded data affects the recognition result to what extent. Accordingly, for example, when AI to which the BP method, the GBP method, or the selective BP method is not applied (or is not applicable) is used as the CNN unit 320, the important feature map generation unit 350 generates the important feature map by analyzing similar information.

Note that, for example, the method of generating the important feature map by the error back propagation method is

disclosed in documents such as

“Selvaraju, Ramprasaath R., et al., “Grad-cam: Visual explanations from deep networks via gradient-based localization.”, The IEEE International Conference on Computer Vision (ICCV), 2017, pp. 618-626”.

The aggregation unit 360 aggregates the degree of influence on the recognition result in block units, based on the important feature map and calculates the aggregated value of the degree of influence for each block. In addition, the aggregation unit 360 stores the calculated aggregated value of each block in the aggregation result storage unit 380 in association with the quantization value.

The quantization value designation unit 370 is an example of a designation unit and designates an optimum quantization value for each block, based on the aggregated value of each block (a number of aggregated values according to the number of quantization values) stored in the aggregation result storage unit 380. In addition, the quantization value designation unit 370 notifies the output unit 340 of the designated optimum quantization value for each block.

In this manner, the analysis device 120 calculates the degree of tolerance (quantization value) to deterioration (influence on the recognition accuracy) due to the compression process, which the feature part that is important when the CNN unit 320 performs the recognition process has, with the concept perceived by the CNN unit 320 as a reference, instead of the concept perceived by humans.

### <Specific Example of Aggregation Result>

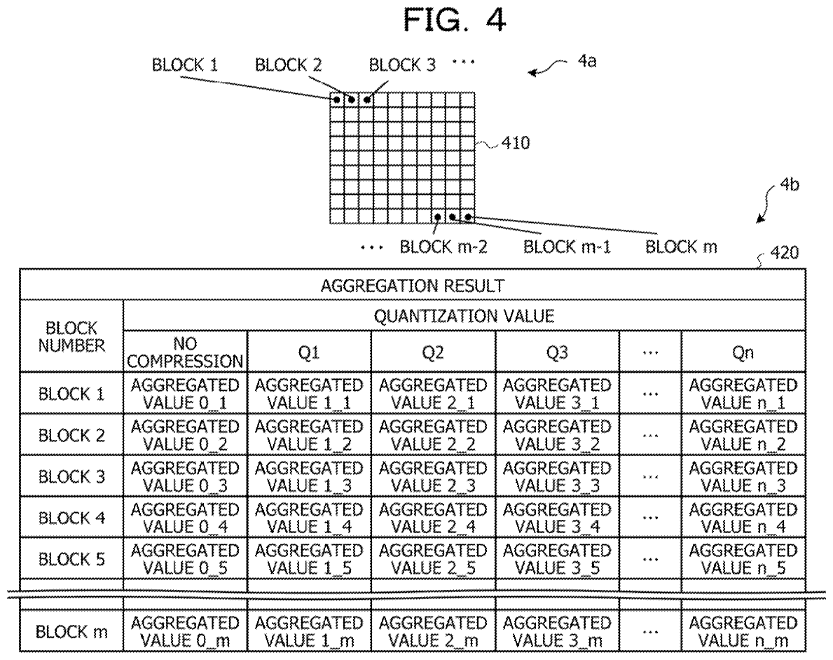

Next, a specific example of the aggregation result stored in the aggregation result storage unit 380 will be described. FIG. 4 is a diagram illustrating a specific example of the aggregation result. In this, an example of the arrangement of blocks in image data 410 is indicated by 4a. As indicated by 4a, in the present embodiment, for the sake of brevity, it is assumed that all the blocks in the image data 410 have the same dimensions. In addition, the block number of the upper left block of the image data is assumed as “block 1”, and the block number of the lower right block is assumed as “block m”.

As indicated by 4b, an aggregation result 420 includes “block number” and “quantization value” as information items.

In “block number”, the block number of each block in the image data 410 is stored. In “quantization value”, “no compression” indicating a case where the image compression device 130 does not perform the compression process, and the minimum quantization value (“Q₁”) to the maximum quantization value (“Qₙ”) used when the image compression device 130 performs the compression process are stored.

In addition, the area specified by “block number” and “quantization value” stores

an aggregated value aggregated in the corresponding block in such a manner that
the compression process is performed on the image data 410, using the corresponding quantization value, and
the learned model performs the recognition process by inputting the decoded data obtained by decoding the acquired compressed data,
based on the important feature map calculated when the recognition process was performed.

### <Specific Example of Processing by Quantization Value Designation Unit>

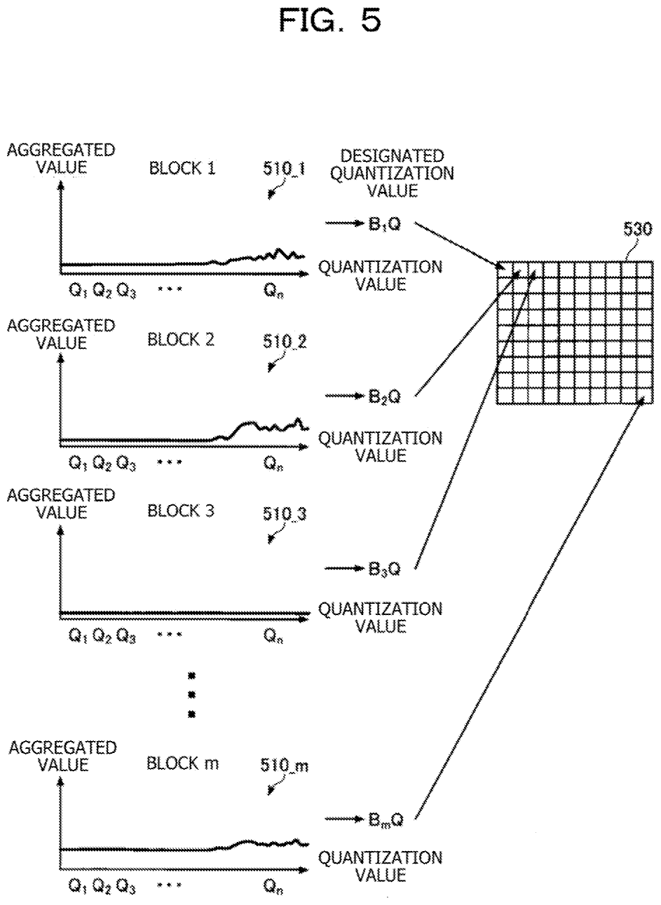

Next, a specific example of processing by the quantization value designation unit 370 will be described. FIG. 5 is a first diagram illustrating a specific example of processing by the quantization value designation unit. In

FIG. 5, graphs 510_1 to 510_m are graphs generated by plotting the aggregated values of each block included in the aggregation result 420, with the quantization value on the horizontal axis and the aggregated value on the vertical axis.

Note that the aggregated values of each block used to generate the graphs 510_1 to 510_m, for example,
may be adjusted using an offset value common to all the blocks,
may be aggregated by taking absolute values, or
the aggregated values of other blocks may be modified based on the aggregated values of the blocks that are not focused.

As illustrated in the graphs 510_1 to 510_m, the change in the aggregated value when changed from the minimum quantization value (Q₁) to the maximum quantization value (Qₙ) differs from block to block. The quantization value designation unit 370 designates the optimum quantization value of each block,

for example, when any of the following conditions is satisfied:
when the magnitude of the aggregated value exceeds a predetermined threshold value, or
when the amount of change in the aggregated value exceeds a predetermined threshold value, or
when the slope of the aggregated value exceeds a predetermined threshold value, or
when the change in the slope of the aggregated value exceeds a predetermined threshold value.

In FIG. 5, the reference sign 530 indicates a state in which B₁Q to BₘQ are designated as the optimum quantization values for the blocks 1 to m and are set in the corresponding blocks.

Note that the size of the block at the time of aggregation and the size of the block used for the compression process do not have to match. In that case, for example, the quantization value designation unit 370 designates the quantization value as follows.

When the size of the block used for the compression process is larger than the size of the block at the time of aggregation, the average value (alternatively, the minimum value, the maximum value, or a value modified with another index) of the quantization values based on the aggregated value of each block at the time of aggregation contained in the block used for the compression process is adopted as the quantization value of each block used for the compression process.

When the size of the block used for the compression process is smaller than the size of the block at the time of aggregation, the quantization value based on the aggregated value of the block at the time of aggregation is used as the quantization value of each block used for the compression process contained in the block at the time of aggregation.

In addition, the quantization values indicated by the reference sign 530 may be additionally evaluated by the analysis device 120. For example, first, the analysis device 120 decodes the compressed data that has undergone the compression process using the quantization values indicated by the reference sign 530 and performs the recognition process on the decoded data. Subsequently, the analysis device 120 adds a quantization value (for example, adds one) to the minimum value among the quantization values indicated by the reference sign 530 and alters the quantization values indicated by the reference sign 530. At this time, when a plurality of minimum values exists among the quantization values indicated by the reference sign 530, a similar addition is performed.

Subsequently, the analysis device 120 decodes the compressed data that has undergone the compression process using the altered quantization values indicated by the reference sign 530 and performs the recognition process on the decoded data.

The analysis device 120 repeats these processes until the maximum value among the quantization values indicated by the reference sign 530 is reached and acquires a plurality of pairs of the altered quantization values indicated by the reference sign 530 and the corresponding recognition results.

Subsequently, the analysis device 120 selects a pair having a recognition accuracy falling above an allowable lower limit and having the maximum minimum value of the quantization value, from among the plurality of pairs and replaces the quantization value indicated by the reference sign 530 (before the alteration) using the altered quantization value indicated by the reference sign 530 and contained in the selected pair.

In this manner, by additionally evaluating the quantization values indicated by the reference sign 530, a quantization value having a higher compression rate than the compression rates of the quantization values indicated by the reference sign 530 may be designated.

### <Functional Configuration of Image Compression Device>

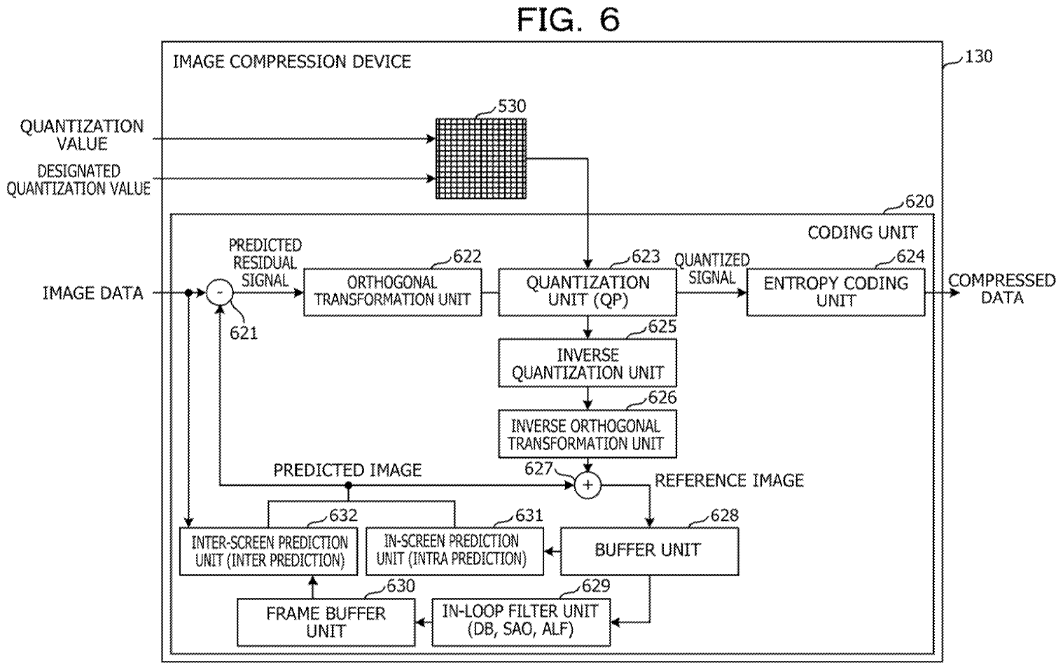

Next, a functional configuration of the image compression device 130 will be described. FIG. 6 is a first diagram illustrating an example of the functional configuration of the image compression device. As described above, an image compression program is installed in the image compression device 130, and when the program is executed, the image compression device 130 functions as a coding unit 620.

The coding unit 620 is an example of a compression unit. The coding unit 620 includes a difference unit 621, an orthogonal transformation unit 622, a quantization unit 623, an entropy coding unit 624, an inverse quantization unit 625, and an inverse orthogonal transformation unit 626. In addition, the coding unit 620 includes an addition unit 627, a buffer unit 628, an in-loop filter unit 629, a frame buffer unit 630, an in-screen prediction unit 631, and an inter-screen prediction unit 632.

The difference unit 621 calculates the difference between the image data (for example, the image data 410) and predicted image data and outputs a predicted residual signal.

The orthogonal transformation unit 622 executes an orthogonal transformation process on the predicted residual signal output by the difference unit 621.

The quantization unit 623 quantizes the predicted residual signal that has undergone the orthogonal transformation process and generates a quantized signal. The quantization unit 623 generates the quantized signal using the quantization value indicated by the reference sign 530 (the quantization value transmitted from the analysis device 120 or the designated optimum quantization value).

The entropy coding unit 624 generates compressed data by performing an entropy coding process on the quantized signal.

The inverse quantization unit 625 inverse-quantizes the quantized signal. The inverse orthogonal transformation unit 626 executes an inverse orthogonal transformation process on the inverse-quantized quantized signal.

The addition unit 627 generates reference image data by adding the signal output from the inverse orthogonal transformation unit 626 and the predicted image data. The buffer unit 628 stores the reference image data generated by the addition unit 627.

The in-loop filter unit 629 performs a filter process on the reference image data stored in the buffer unit 628. The in-loop filter unit 629 includes
a deblocking filter (DB),
a sample adaptive offset filter (SAO), and
an adaptive loop filter (ALF).

The frame buffer unit 630 stores the reference image data on which the filter process has been performed by the in-loop filter unit 629, in frame units.

The in-screen prediction unit 631 performs in-screen prediction based on the reference image data and generates the predicted image data. The inter-screen prediction unit 632 performs motion compensation between frames using the input image data (for example, the image data 410) and the reference image data and generates the predicted image data.

Note that the predicted image data generated by the in-screen prediction unit 631 or the inter-screen prediction unit 632 is output to the difference unit 621 and the addition unit 627.

In addition, in the above description, it is assumed that the coding unit 620 performs the compression process using an existing moving image coding scheme such as moving picture experts group (MPEG)-2, MPEG-4, H.264, or high efficiency video coding (HEVC). However, the compression process by the coding unit 620 is not limited to these moving image coding schemes and may be performed using any coding scheme in which the compression rate is controlled by parameters such as quantization.

### <Flow of Image Compression Process by Compression Processing System>

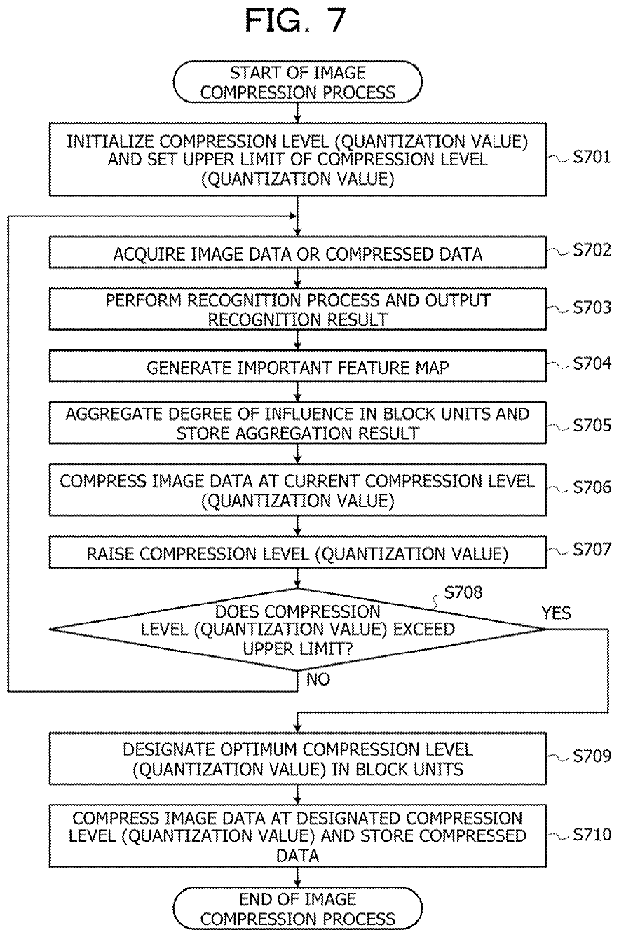

Next, a flow of an image compression process by a compression processing system 100 will be described. FIG. 7 is a first flowchart illustrating an example of the flow of the image compression process by the compression processing system.

In step S701, the quantization value setting unit 330 initializes the compression level (sets the minimum quantization value (Q₁)) and also sets the upper limit of the compression level (sets the maximum quantization value (Qₙ)).

In step S702, the input unit 310 acquires image data or compressed data in frame units. In addition, when the compressed data is acquired, the input unit 310 decodes the acquired compressed data and generates decoded data.

In step S703, the CNN unit 320 performs the recognition process on the image data (or the decoded data) and outputs the recognition result.

In step S704, the important feature map generation unit 350 generates the important feature map indicating the degree of influence of each area on the recognition result, based on the CNN unit structure information.

In step S705, the aggregation unit 360 aggregates the degree of influence of each area in block units, based on the important feature map. In addition, the aggregation unit 360 stores the aggregation result in the aggregation result storage unit 380 in association with the current compression level (quantization value).

In step S706, the output unit 340 transmits the image data and the current compression level (quantization value) to the image compression device 130. In addition, the image compression device 130 performs the compression process on the transmitted image data at the current compression level (quantization value) and generates compressed data.

In step S707, the quantization value setting unit 330 raises the compression level (here, sets the quantization value (Q₂)).

In step S708, the quantization value designation unit 370 determines whether or not the current compression level exceeds the upper limit (whether or not the current quantization value exceeds the maximum quantization value (Qₙ)). When it is determined in step S708 that the current compression level does not exceed the upper limit (in the case of No in step S708), the process returns to step S702.

In this case, in step S702, the compressed data generated in step S706 is acquired, and the processes in steps S703 to S707 are performed on decoded data obtained by decoding the acquired compressed data.

On the other hand, when it is determined in step S708 that the current compression level exceeds the upper limit (in the case of Yes in step S708), the process proceeds to step S709.

In step S709, the quantization value designation unit 370 designates the optimum compression level (optimum quantization value) in block units, based on the aggregation result stored in the aggregation result storage unit 380. In addition, the output unit 340 transmits the designated optimum quantization value to the image compression device 130.

In step S710, the image compression device 130 performs the compression process on the image data, using the designated optimum quantization value and stores the compressed data in the storage device 140.

As is clear from the above description, the analysis device according to the first embodiment acquires each piece of compressed data when the compression process is performed on the image data using different quantization values. In addition, the analysis device according to the first embodiment generates the important feature map indicating the degree of influence on the recognition result, based on the CNN unit structure information when the decoded data obtained by decoding each piece of the compressed data was input to the learned model and the recognition process was performed. Furthermore, the analysis device according to the first embodiment aggregates the degree of influence in block units, based on the important feature map and designates the compression level of each block of the image data, based on the aggregated values of each block corresponding to different compression levels.

Consequently, according to the first embodiment, the compression process may be performed using the optimum quantization value designated based on the degree of influence on the recognition result. For example, according to the first embodiment, a compression process suitable for an image recognition process by AI may be implemented.

### Second Embodiment

In the first embodiment described above, in designating the optimum quantization value based on the degree of influence on the recognition result, the minimum quantization value to the maximum quantization value that can be set in the image compression device 130 have been described as being all used.

In contrast to this, in a second embodiment, a case where the optimum quantization value is designated by performing the compression process using a predetermined quantization value will be described. The second embodiment will be described below focusing on differences from the first embodiment described above.

### <Functional Configuration of Analysis Device>

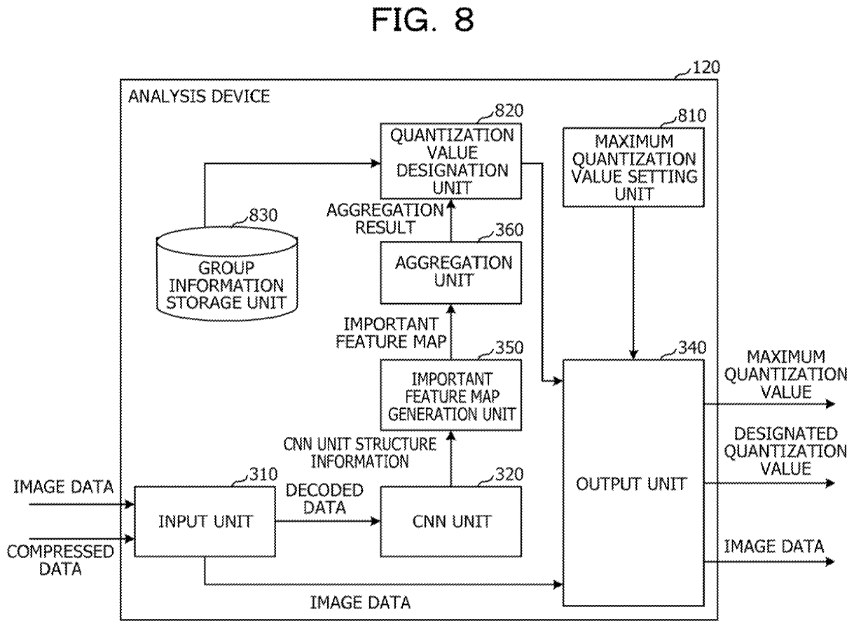

First, a functional configuration of an analysis device 120 according to the second embodiment will be described. FIG. 8 is a second diagram illustrating an example of the functional configuration of the analysis device. The differences from the functional configuration illustrated in FIG. 3 are that a maximum quantization value setting unit 810 is included instead of the quantization value setting unit 330, and the function of a quantization value designation unit 820 is different from the function of the quantization value designation unit 370. In addition, the analysis device 120 includes a group information storage unit 830 instead of the aggregation result storage unit 380.

The maximum quantization value setting unit 810 notifies an output unit 340 of the maximum quantization value (Qₙ). The quantization value designation unit 820 determines a group to which the aggregated value of each block notified by an aggregation unit 360 belongs, from group information stored in the group information storage unit 830, which is an example of the storage unit. In addition, the quantization value designation unit 820 notifies the output unit 340 of the optimum quantization value associated with the determined group in advance.

### <Specific Example of Processing by Quantization Value Designation Unit>

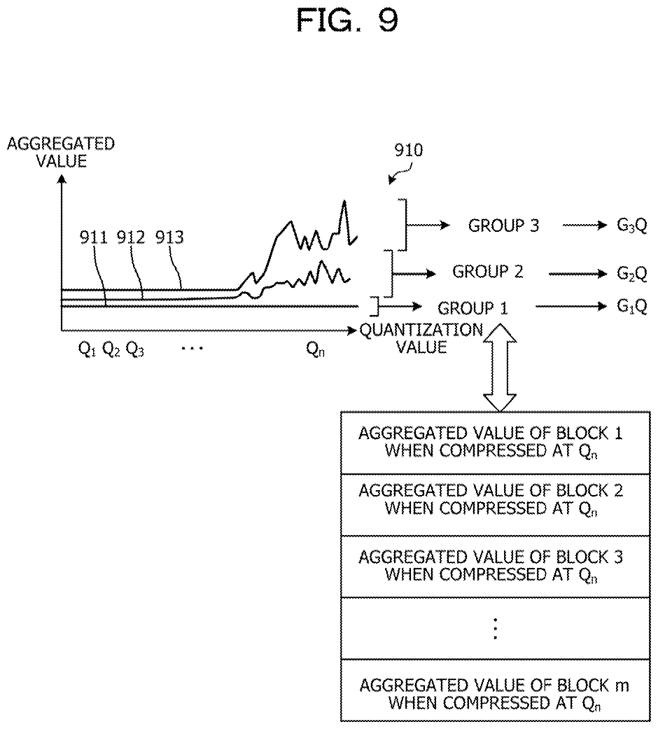

Next, a specific example of processing by the quantization value designation unit 820 will be described. FIG. 9 is a second diagram illustrating a specific example of processing by the quantization value designation unit.

As illustrated in FIG. 9, in group information 910, groups including a plurality of standard patterns of aggregated values when the minimum quantization value is changed to the maximum quantization value (in the example in FIG. 9, three patterns indicated by graphs 911 to 913) are defined. In addition, the optimum quantization value is defined in the group information 910 for each group. The example in FIG. 9 indicates that
an optimum quantization value G₁Q is associated with a group 1,
an optimum quantization value G₂Q is associated with a group 2, and
an optimum quantization value G₃Q is associated with a group 3,

individually.

The quantization value designation unit 820 acquires, from the aggregation unit 360, the aggregated value of each block calculated by performing the recognition process on the decoded data obtained by decoding the compressed data when the compression process is performed on the image data using the maximum quantization value (Qₙ). In addition, the quantization value designation unit 820 determines which group the aggregated value of each block belongs to.

Furthermore, the quantization value designation unit 820 notifies the output unit 340 of the quantization value associated with the determined group, as the optimum quantization value of each block.

Note that, in the example in FIG. 9, only one type of the group information 910 is illustrated, but there may be a plurality of types of group information. For example, different kinds of group information may be prepared for each type of object targeted for the recognition process. Alternatively, different kinds of group information may be prepared for each degree of complexity of the image data.

In addition, in the example in FIG. 9, the group information 910 has been described as including the graphs 911 to 913, but may include a model such as an approximate function or deep learning.

Furthermore, in the example in FIG. 9, the maximum quantization value (Qₙ) is used in determining the group, but a plurality of quantization values including the maximum quantization value (Qₙ) or a plurality of quantization values not including the maximum quantization value (Qₙ) may be used.

### <Flow of Image Compression Process by Compression Processing System>

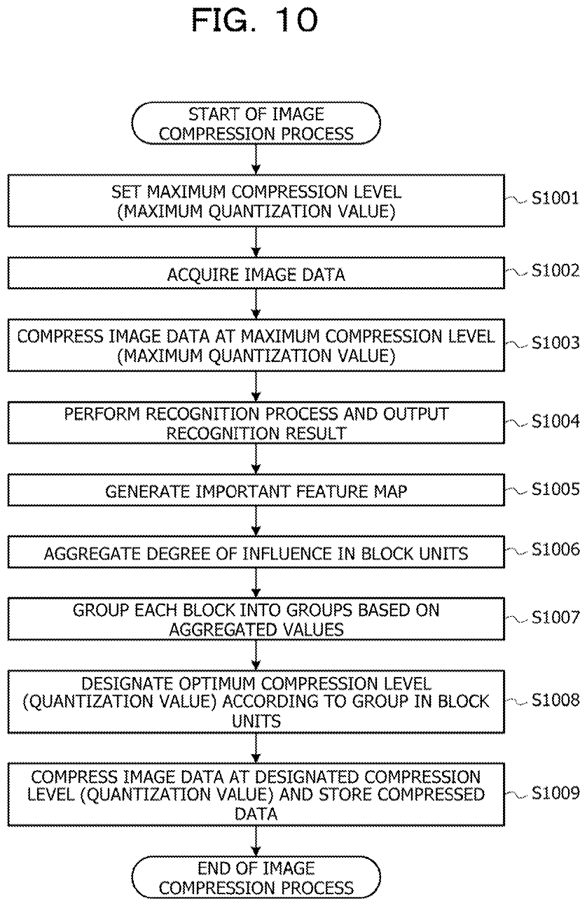

Next, a flow of an image compression process by a compression processing system 100 will be described. FIG. 10 is a second flowchart illustrating an example of the flow of the image compression process by the compression processing system.

In step S1001, the maximum quantization value setting unit 810 sets the maximum compression level (maximum quantization value (Qₙ)).

In step S1002, an input unit 310 acquires image data in frame units.

In step S1003, the output unit 340 transmits the image data and the maximum compression level (maximum quantization value (Qₙ)) to an image compression device 130. In addition, the image compression device 130 performs the compression process on the transmitted image data at the maximum compression level (maximum quantization value (Qₙ)) and generates compressed data.

In step S1004, the input unit 310 acquires and decodes the compressed data generated by the image compression device 130. In addition, a CNN unit 320 performs the recognition process on the decoded data and outputs the recognition result.

In step S1005, an important feature map generation unit 350 generates the important feature map indicating the degree of influence on the recognition result, based on the CNN unit structure information.

In step S1006, the aggregation unit 360 aggregates the degree of influence of each area in block units, based on the important feature map. In addition, the aggregation unit 360 notifies the quantization value designation unit 820 of the aggregation result.

In step S1007, the quantization value designation unit 820 refers to the group information stored in the group information storage unit 830 and determines which group the aggregated value of each block notified by the aggregation unit 360 belongs to. This causes the quantization value designation unit 820 to group each block into groups.

In step S1008, the quantization value designation unit 820 designates the optimum quantization value associated with each of groups determined for each block, as the optimum quantization value of each block. In addition, the output unit 340 transmits the designated optimum quantization value to the image compression device 130.

In step S1009, the image compression device 130 performs the compression process on the image data, using the designated optimum quantization value and stores the compressed data in a storage device 140.

As is clear from the above description, the analysis device according to the second embodiment acquires the compressed data when the compression process is performed on the image data using the maximum quantization value. In addition, the analysis device according to the second embodiment generates the important feature map indicating the degree of influence on the recognition result, based on the CNN unit structure information when the recognition process was performed by inputting the decoded data obtained by decoding the compressed data to the learned model. Furthermore, the analysis device according to the second embodiment aggregates the degree of influence in block units, based on the important feature map and, by determining a group to which the aggregated value belongs, designates the quantization value associated with the group, as the optimum quantization value.

Consequently, according to the second embodiment, the compression process may be performed using the optimum quantization value designated based on the degree of influence on the recognition result. For example, according to the second embodiment, an effect similar to the effect of the first embodiment described above is obtained. Besides, according to the second embodiment, the optimum quantization value may be designated with a smaller number of compression processes as compared with the first embodiment described above.

### Third Embodiment

In the second embodiment described above, in determining the group to which the aggregated value belongs, the recognition process has been described as being performed on the decoded data obtained by decoding the compressed data when the compression process is performed using the maximum quantization value. In contrast to this, in a third embodiment, pseudo-like compressed data (pseudo-compressed data) is generated by performing image processing having an equivalent effect to the effect of performing the compression process using the maximum quantization value, and the recognition process is performed on the pseudo-compressed data. Consequently, according to the third embodiment, the optimum quantization value may be designated with a still smaller number of compression processes as compared with the second embodiment. The third embodiment will be described below focusing on differences from the second embodiment described above.

### <Functional Configuration of Analysis Device>

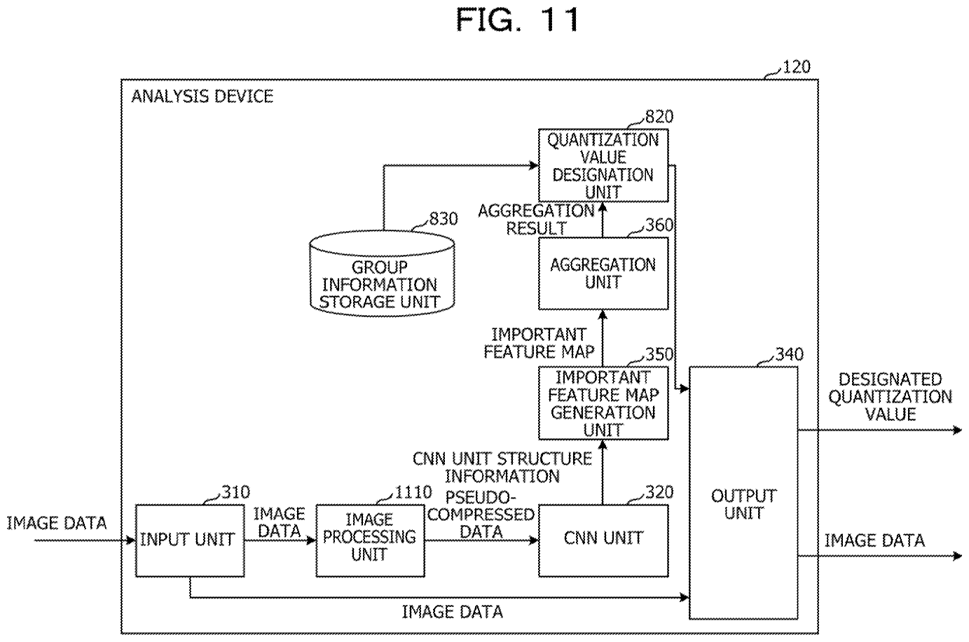

First, a functional configuration of an analysis device 120 according to the third embodiment will be described. FIG. 11 is a third diagram illustrating an example of the functional configuration of the analysis device. The differences from the functional configuration illustrated in FIG. 8 are that the maximum quantization value setting unit 810 is not included, and an image processing unit 1110 is included.

The image processing unit 1110 performs a filtering process on the image data acquired by an input unit 310, for example, using a low-pass filter. This causes the image processing unit 1110 to generate the pseudo-compressed data having a similar effect to the effect of performing the compression process on the image data using the maximum quantization value.

In addition, the image processing unit 1110 inputs the generated pseudo-compressed data to a CNN unit 320. This causes the CNN unit 320 to perform the recognition process on the pseudo-compressed data and causes an important feature map generation unit 350 to generate the important feature map based on the CNN unit structure information. Furthermore, an aggregation unit 360 aggregates the important feature map in block units, and the quantization value designation unit 820 determines a group to which the aggregated value of each block belongs, from the group information stored in a group information storage unit 830, whereby the output unit 340 is notified of the optimum quantization value.

### <Specific Example of Processing by Quantization Value Designation Unit>

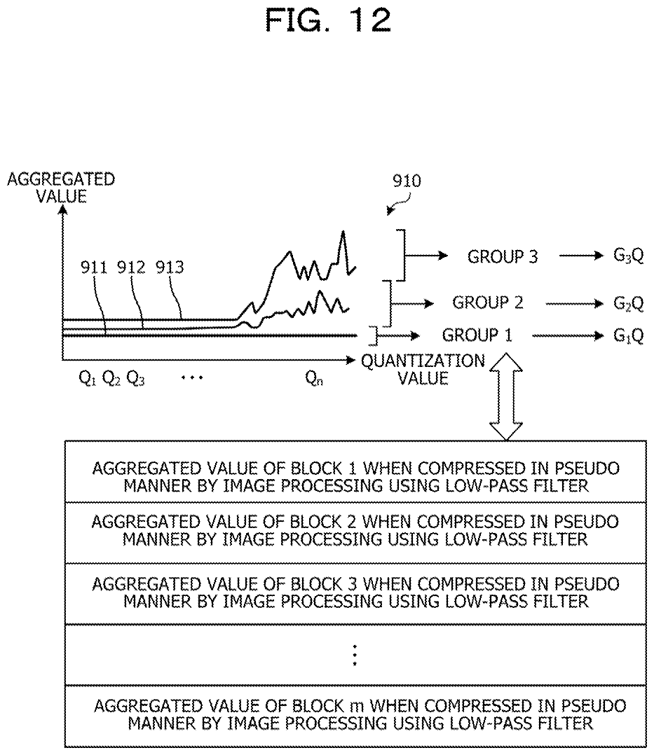

Next, a specific example of processing by the quantization value designation unit 820 will be described. FIG. 12 is a third diagram illustrating a specific example of processing by the quantization value designation unit. The difference from FIG. 9 is that the quantization value designation unit 820 acquires the aggregated value of each block when the recognition process is performed on the pseudo-compressed data that has undergone the filtering process using the low-pass filter.

Note that the quantization value designation unit 820 determines which group each block belongs to, based on the acquired aggregated value of each block and notifies the output unit 340 of the optimum quantization value associated with the determined group, as the optimum quantization value of each block.

### <Flow of Image Compression Process by Compression Processing System>

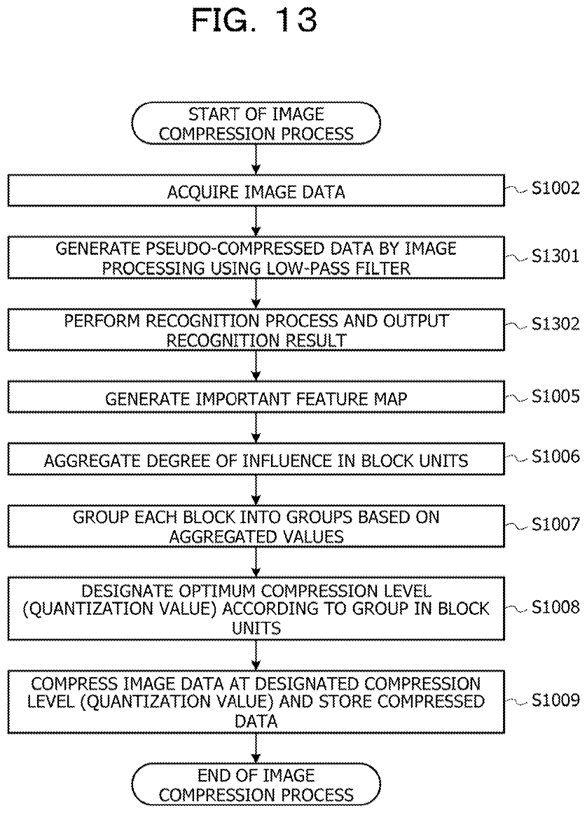

Next, a flow of an image compression process by a compression processing system 100 will be described. FIG. 13 is a third flowchart illustrating an example of the flow of the image compression process by the compression processing system. Note that the differences from the second flowchart illustrated in FIG. 10 are that the process in step S1001 is not included, and the processes in steps S1301 and S1302 are included instead of the processes in steps S1003 and S1004.

In step S1301, the image processing unit 1110 generates the pseudo image data by the filtering process using the low-pass filter and inputs the generated pseudo image data to the CNN unit 320.

In step S1302, the input unit 310 acquires the pseudo image data, and the CNN unit 320 performs the recognition process on the acquired pseudo image data and outputs the recognition result.

As is clear from the above description, the analysis device according to the third embodiment performs the filtering process on the image data and acquires the pseudo-compressed data. In addition, the analysis device according to the third embodiment generates the important feature map indicating the degree of influence on the recognition result, based on the CNN unit structure information when the recognition process was performed by inputting the pseudo-compressed data to the learned model. Furthermore, the analysis device according to the third embodiment aggregates the degree of influence in block units, based on the important feature map and, by determining a group to which the aggregated value belongs, designates the quantization value associated with the group, as the optimum quantization value.

Consequently, according to the third embodiment, the compression process may be performed using the optimum quantization value designated based on the degree of influence on the recognition result. For example, according to the third embodiment, an effect similar to the effect of the first embodiment described above is obtained. Besides, according to the third embodiment, the optimum quantization value may be designated with a smaller number of compression processes as compared with the first and second embodiments described above.

### Fourth Embodiment

In the first embodiment described above, the compression process has been described as being performed using different quantization values each time one piece of image data in frame units is input, to designate the optimum quantization value. In contrast to this, in the fourth embodiment, the compression process is performed using different quantization values while a plurality of pieces of image data in frame units is input and the optimum quantization value is designated. The fourth embodiment will be described below focusing on differences from the first embodiment described above.

### <Functional Configuration of Analysis Device>

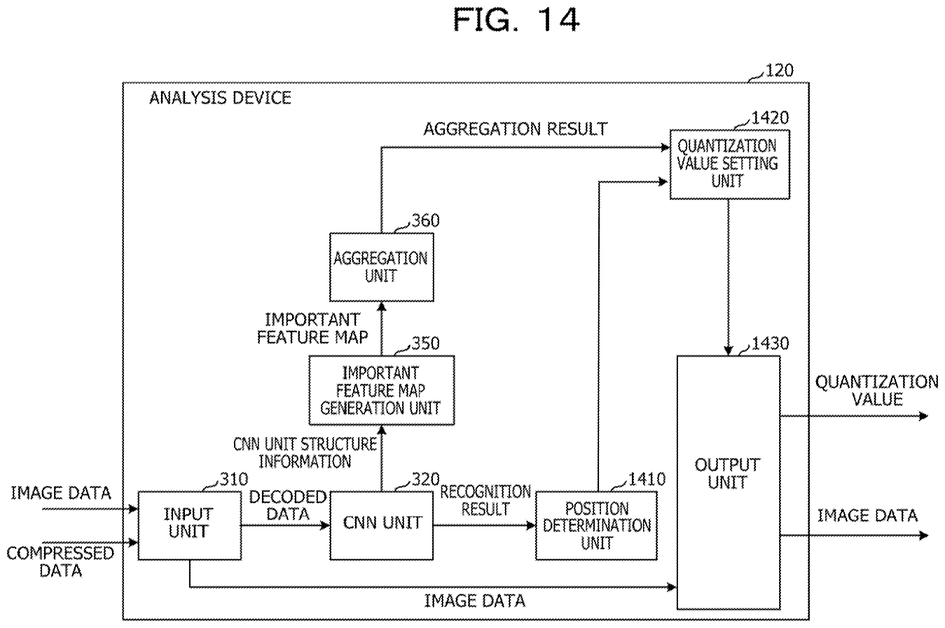

First, a functional configuration of an analysis device 120 according to the fourth embodiment will be described. FIG. 14 is a fourth diagram illustrating an example of the functional configuration of the analysis device. The differences from the functional configuration illustrated in FIG. 3 are that a position determination unit 1410 is included, the function of a quantization value setting unit 1420 is different from the function of the quantization value setting unit 330, and the quantization value designation unit 370 and the aggregation result storage unit 380 are not included.

The position determination unit 1410 extracts position information on the object included in the decoded data obtained by decoding the image data or the compressed data, from the recognition result output from a CNN unit 320.

In addition, the position determination unit 1410 notifies the quantization value setting unit 1420 of the extracted position information.

The quantization value setting unit 1420 notifies an output unit 1430 of the compression level (quantization value) used when an image compression device 130 performs the compression process. The quantization value setting unit 1420 sequentially notifies the output unit 1430 of the quantization values obtained by making additions on a predetermined increment basis, by starting from the minimum quantization value.

In addition, the quantization value setting unit 1420 monitors the aggregated value of each block notified by an aggregation unit 360 each time making a notification of the quantization value and, when the aggregated value of each block exceeds a predetermined threshold value, lowers the quantization value. In this manner, the quantization value setting unit 1420 is capable of controlling the quantization value of which a notification is to be made such that the aggregated value does not exceed a predetermined threshold value.

Note that the quantization value setting unit 1420 specifies a block of which the aggregated value is monitored, based on the position information on the object notified by the position determination unit 1410 and controls the quantization value of the specified block, based on the aggregated value of the specified block.

### <Specific Example of Processing by Quantization Value Setting Unit>

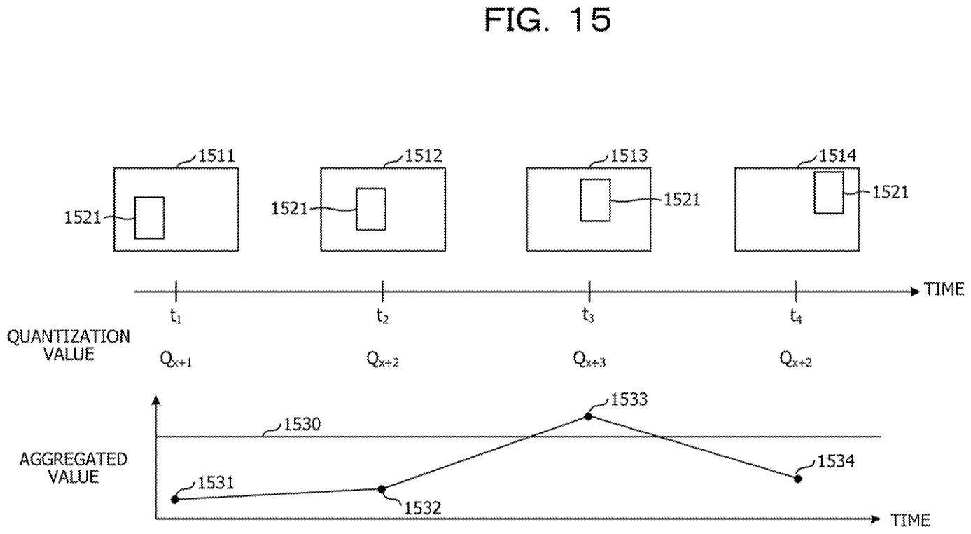

Next, a specific example of processing by the quantization value setting unit 1420 will be described. FIG. 15 is a diagram illustrating a specific example of processing by the quantization value setting unit. In FIG. 15, decoded data 1511 to 1514 obtained by decoding the compressed data indicates decoded data obtained by decoding the compressed data acquired by an input unit 310 at time=t₁ to t₄, respectively.

The decoded data 1511 to 1514 obtained by decoding the compressed data each includes an object 1521. The example in FIG. 15 illustrates a state in which the object 1521 moves from the lower left toward the upper right over time in the decoded data 1511 to 1514 obtained by decoding the compressed data.

The quantization value setting unit 1420 specifies the position of the object 1521 in the decoded data 1511 to 1514 obtained by decoding the compressed data, based on the position information notified by the position determination unit 1410.

In addition, the quantization value setting unit 1420 acquires the aggregated value of each block included in the specified position, from the aggregation unit 360. In FIG. 15, reference signs 1531 to 1534 indicate the aggregated values of the blocks included in the specified positions, of which the quantization value setting unit 1420 has been notified by the aggregation unit 360.

The example in FIG. 15 illustrates a state in which the quantization value setting unit 1420 has made notifications of quantization values Qₓ₊₁, Qₓ₊₂, and Qₓ₊₃ on a predetermined increment basis (where Qₓ₊₁<Qₓ₊₂<Qₓ₊₃ holds).

Here, it is assumed that the aggregated value (reference sign 1533) of a block included in the object 1521, which has been calculated by performing the recognition process on the decoded data 1513 obtained by decoding the compressed data when the compression process is performed using the quantization value Qₓ₊₃, exceeds a predetermined threshold value 1530.

In this case, the quantization value setting unit 1420 makes the quantization value of which the notification is to be made next, be a quantization value smaller than the quantization value Qₓ₊₃ (the example in FIG. 15 illustrates a state in which the notification of the quantization value Qₓ₊₂ is made).

In this manner, by controlling the quantization value of which the notification is to be made such that the aggregated value of each block included in the object does not exceed a predetermined threshold value, the quantization value setting unit 1420 may continuously make notifications of the optimum quantization value.

### <Flow of Image Compression Process by Compression Processing System>

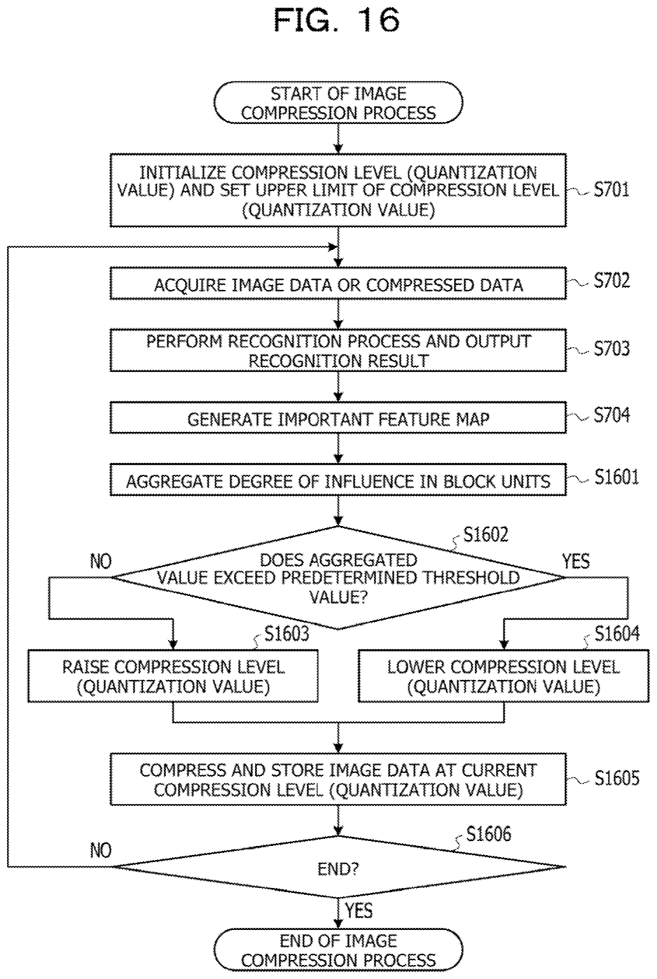

Next, a flow of an image compression process by a compression processing system 100 will be described. FIG. 16 is a fourth flowchart illustrating an example of the flow of the image compression process by the compression processing system. Note that the differences from the first flowchart illustrated in FIG. 7 are steps S1601 to S1606.

In step S1601, the aggregation unit 360 aggregates the degree of influence of each area in block units, based on the important feature map.

In step S1602, the quantization value setting unit 1420 specifies the position of the object, based on the position information notified by the position determination unit 1410 and determines whether or not the aggregated value of each block included in the specified position of the object exceeds a predetermined threshold value.

When it is determined in step S1602 that the predetermined threshold value is not exceeded (in the case of No in step S1602), the process proceeds to step S1603.

In step S1603, the quantization value setting unit 1420 makes an addition to the quantization value on a predetermined increment basis and notifies the output unit 1430 of the quantization value after the addition.

On the other hand, when it is determined in step S1602 that the predetermined threshold value is exceeded (in the case of Yes in step S1602), the process proceeds to step S1604.

In step S1604, the quantization value setting unit 1420 makes a subtraction from the quantization value on a predetermined increment basis and notifies the output unit 1430 of the quantization value after the subtraction.

In step S1605, the image compression device 130 performs the compression process on the image data, using the quantization value transmitted from the output unit 1430 and stores the compressed data in a storage device 140.

In step S1606, the input unit 310 determines whether or not to end the image compression process and, when it is determined not to end (in the case of No in step S1606), the process returns to step S702. On the other hand, when it is determined in step S1606 to end (in the case of Yes in step S1606), the image compression process ends.

As is clear from the above description, the analysis device according to the fourth embodiment acquires each piece of compressed data when the compression process is performed on each of a plurality of pieces of the image data using different quantization values. In addition, the analysis device according to the fourth embodiment generates the important feature map indicating the degree of influence on the recognition result, based on the CNN unit structure information when the decoded data obtained by decoding each piece of the compressed data was input to the learned model and the recognition process was performed. Furthermore, the analysis device according to the fourth embodiment aggregates the important feature map in block units and acquires the aggregated values of the blocks included in the position of the object. Moreover, the analysis device according to the fourth embodiment controls the quantization value such that the acquired aggregated value does not exceed a predetermined threshold value.

In this manner, by controlling the quantization value such that the aggregated value of each block included in the object does not exceed a predetermined threshold value, according to the analysis device according to the fourth embodiment, the optimum quantization value may be continuously output.

### Fifth Embodiment

In the first to third embodiments described above, the aggregated value has been described as being calculated for each block, and the optimum quantization value has been described as being designated for each block. In contrast to this, in the fifth embodiment, comparison with the aggregated value of a reference block is made, and the optimum quantization value is designated based on the comparison result. The fifth embodiment will be described below focusing on differences from the first embodiment described above.

### <Specific Example of Processing by Quantization Value Designation Unit>

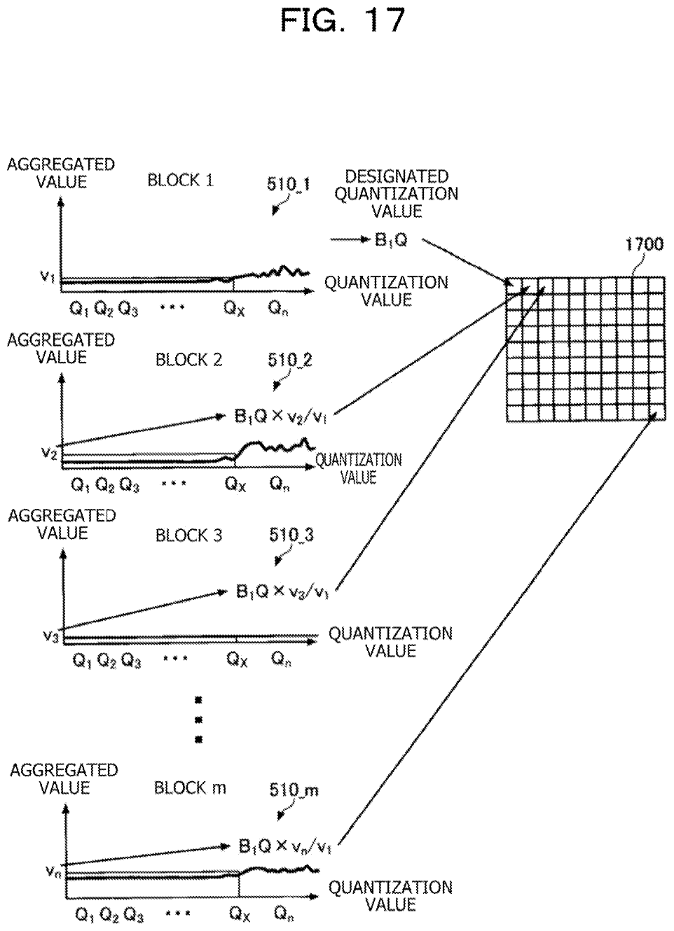

FIG. 17 is a fourth diagram illustrating a specific example of processing by a quantization value designation unit. In FIG. 17, graphs 510_1 to 510_m are the same as the graphs 510_1 to 510_m already described with reference to FIG. 5.

Here, in the example in FIG. 17, the block number=“block 1” is adopted as the reference block, and it is assumed that the aggregated value of the block is “v₁”, and the optimum quantization value of the block is “B₁Q”.

In this case, for example, the quantization value designation unit calculates
the optimum quantization value=B₁Q×v₂/v₁ for the block 2,
the optimum quantization value=B₁Q×v₃/v₁ for the block 3,
   . . . , and
the optimum quantization value=B₁Q×vₘ/v₁ for the block m,
individually. This causes the quantization value designation unit to designate optimum quantization values 1700.

### <Flow of Image Compression Process by Compression Processing System>

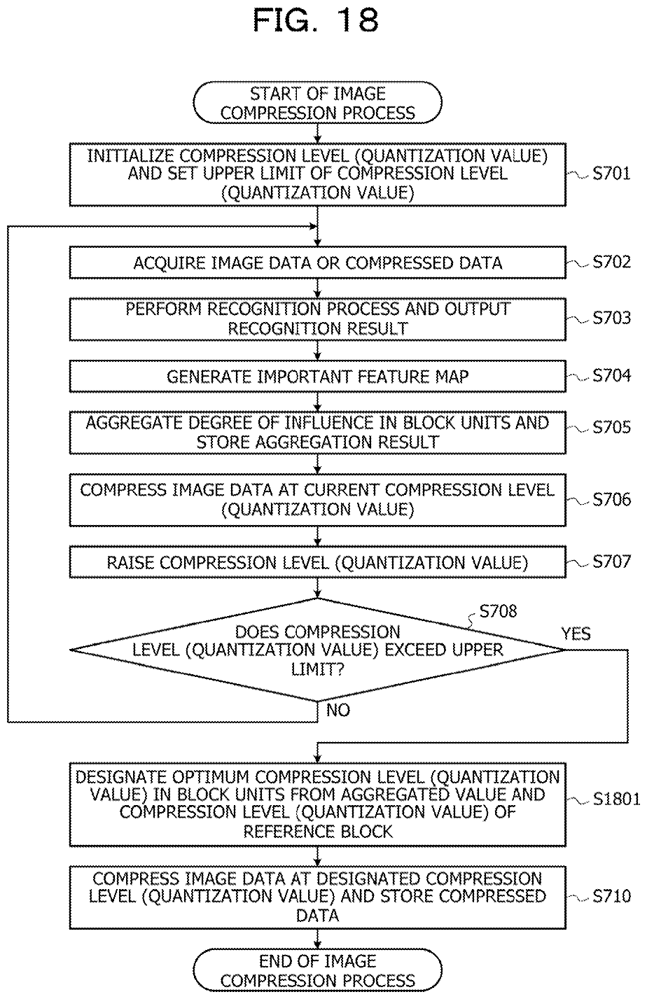

FIG. 18 is a fifth flowchart illustrating an example of the flow of an image compression process by a compression processing system. The difference from the first flowchart illustrated in FIG. 7 is step S1801.

In step S1801, the quantization value designation unit compares the aggregated value of the reference block and the aggregated value of each block and designates the optimum quantization value of each block, based on the optimum quantization value of the reference block and the comparison result.

In this manner, by comparing with the aggregated value of the reference block and designating the optimum quantization value based on the comparison result, according to the fifth embodiment, the compression process may be performed at a compression level equal to or higher than a predetermined compression level, regardless of the image data. In addition, according to the fifth embodiment, the quantization values may be aligned between the blocks.

### Sixth Embodiment

In the first to third embodiments described above, the aggregated value has been described as being calculated for each block, and the quantization value has been described as being designated based on the calculated aggregated value. In contrast to this, in the sixth embodiment, by correcting the quantization value preset in an image compression device 130 (the quantization value set based on the human visual characteristics) using the calculated aggregated value, the optimum quantization value is designated. The sixth embodiment will be described below focusing on differences from the first embodiment described above.

### <Specific Example of Processing by Quantization Value Designation Unit>

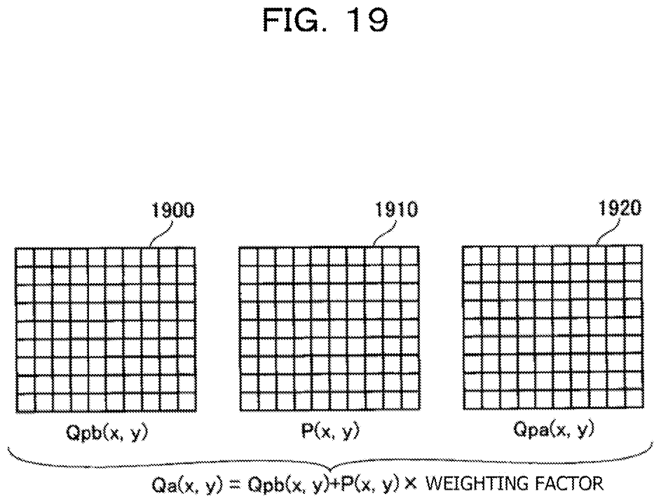

FIG. 19 is a fifth diagram illustrating a specific example of processing by a quantization value designation unit. In FIG. 19, quantization values 1900 are quantization values preset in the image compression device 130 and are quantization values set based on the human visual characteristics.

In addition, in FIG. 19, an aggregation result 1910 is an aggregation result when the recognition process is performed on the decoded data obtained by decoding predetermined compressed data. The predetermined compressed data mentioned here refers to compressed data when the compression process is performed using the quantization value set immediately before setting the quantization value when an erroneous recognition result was output in the recognition process by a CNN unit 320 for the decoded data obtained by decoding.

In addition, in FIG. 19, optimum quantization values 1920 are quantization values calculated based on the quantization values 1900 and the aggregation result 1910. As illustrated in FIG. 19, the optimum quantization values 1920 are calculated based on the following equation (equation 1).

Qa(x, y)=Qpb(x, y)+P(x, y)×Weighting Factor (Equation 1)

Note that, in equation 1, Qa(x, y) refers to the optimum quantization value of a block specified by coordinates (x, y). In addition, in equation 1, Qpb(x, y) refers to a quantization value of the block specified by the coordinates (x, y), which is a quantization value preset in the image compression device 130. Furthermore, in equation 1, P(x, y) refers to an aggregation result of the block specified by the coordinates (x, y) when the recognition process is performed on the decoded data obtained by decoding the predetermined compressed data.

### <Flow of Image Compression Process by Compression Processing System>

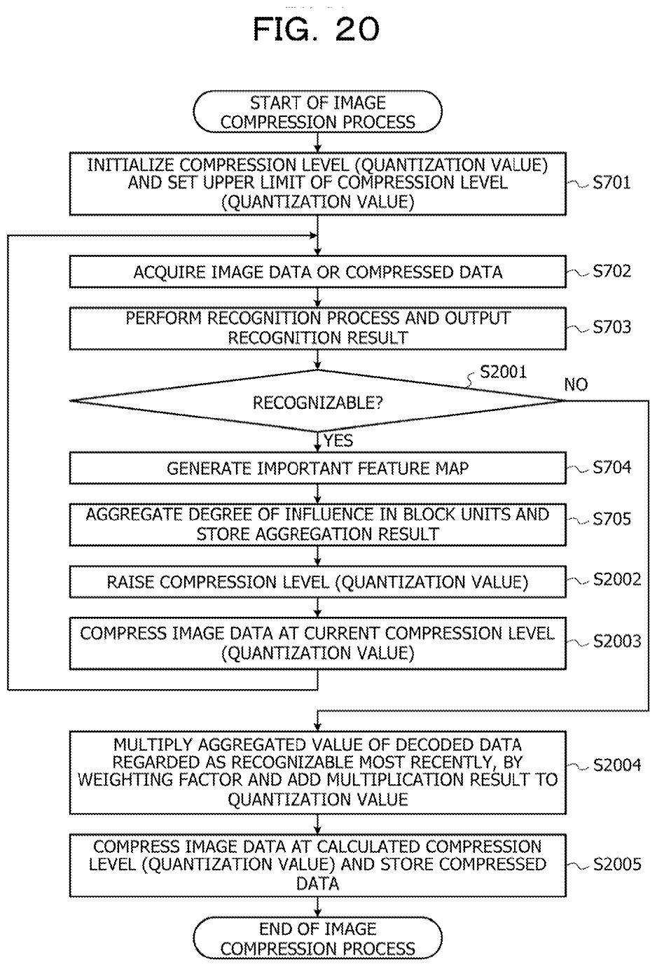

Next, a flow of an image compression process by a compression processing system 100 will be described. FIG. 20 is a sixth flowchart illustrating an example of the flow of the image compression process by the compression processing system. The differences from the first flowchart illustrated in FIG. 7 are steps S2001 and S2002 to 2005.

In step S2001, the quantization value designation unit determines whether or not a precise recognition result has been output from the CNN unit. When it is determined in step S2001 that a precise recognition result has been output (in the case of Yes in step S2001), the process proceeds to step S704.

In step S704, an important feature map generation unit 350 generates the important feature map indicating the degree of influence of each area on the recognition result, based on the CNN unit structure information.

In step S705, an aggregation unit 360 aggregates the degree of influence of each area in block units, based on the important feature map. In addition, the aggregation unit 360 stores the aggregation result in an aggregation result storage unit 380 in association with the current compression level (quantization value).

In step S2002, a quantization value setting unit 330 raises the compression level (quantization value).

In step S2003, an output unit 340 transmits the image data and the current compression level (quantization value) to the image compression device 130. In addition, the image compression device 130 performs the compression process on the transmitted image data using the current compression level (quantization value) and generates compressed data.

On the other hand, when it is determined in step S2001 that an erroneous recognition result has been output (in the case of No in step S2001), the process proceeds to step S2004.

In step S2004, the quantization value designation unit multiplies the aggregated value of the decoded data regarded as recognizable most recently, by the weighting factor and adds the multiplication result to the quantization value preset in the image compression device 130.

In step S2005, the image compression device 130 performs the compression process on the image data using the quantization value calculated in step S2004 and stores the compressed data in a storage device 140.

In this manner, according to the sixth embodiment, by correcting the quantization value preset in the image compression device (the quantization value set based on the human visual characteristics) using the calculated aggregated value, the optimum quantization value may be designated.

### Seventh Embodiment

In the first to sixth embodiments described above, the case where the degree of influence on the recognition result is aggregated in block units and the optimum quantization value is designated based on the aggregation result has been described. In contrast to this, in a seventh embodiment, the image data is divided into an effective area and an invalid area based on the aggregation result, and after the blocks included in the invalid area are invalidated, the compression process is performed on the effective area.

Note that invalidation of the blocks included in the invalid area means, for example, making the pixel value of each pixel of the blocks included in the invalid area be “0”, and image data in which the blocks included in the invalid area are invalidated will be hereinafter referred to as “invalidated image data”.

In this manner, by performing the compression process on the invalidated image data (on the effective area included in the invalidated image data), the data size of the compressed data may be further reduced as compared with the case where the compression process is performed on the entire image data.

Note that, in performing the compression process on the invalidated image data, a quantization value assigned in advance may be used, or the optimum quantization value designated based on the methods described in the first to sixth embodiments described above may be used. In addition, in the case of a compression scheme capable of performing the compression process on data in any form, the compression process may be performed on data obtained by removing the invalid area of the invalidated image data. The seventh embodiment will be described below focusing on differences from the first embodiment described above.

### <Functional Configuration of Analysis Device>

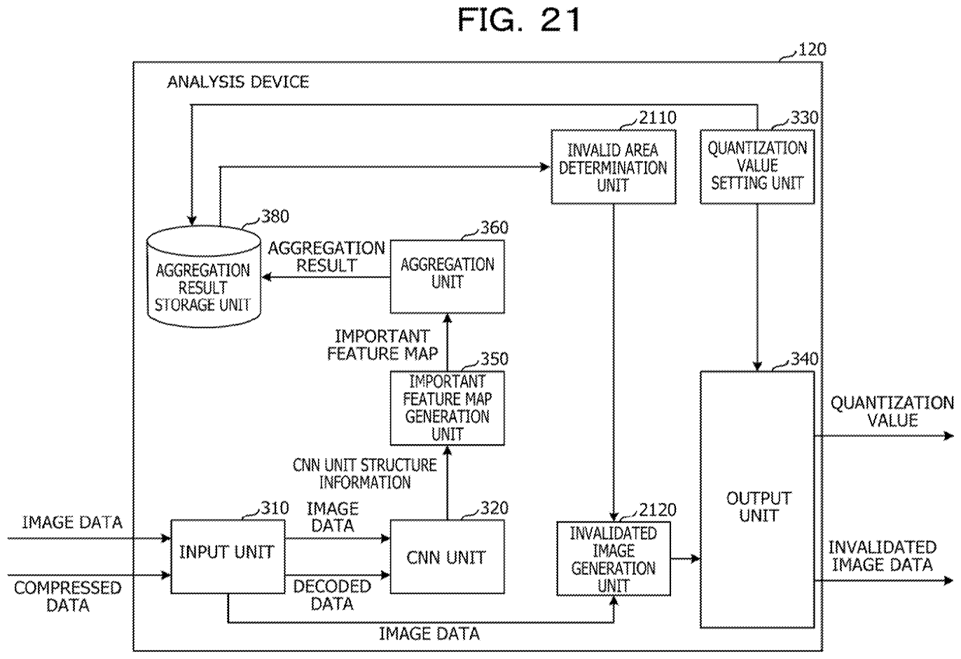

First, a functional configuration of an analysis device 120 according to the seventh embodiment will be described. FIG. 21 is a fifth diagram illustrating an example of the functional configuration of the analysis device. The difference from the functional configuration illustrated in FIG. 3 is that an invalid area determination unit 2110 and an invalidated image generation unit 2120 are included instead of the quantization value designation unit 370.

The invalid area determination unit 2110 determines whether or not each block is a block belonging to the invalid area, based on the aggregated value of the degree of influence of each block on the recognition result (a number of aggregated values according to the number of quantization values) stored in an aggregation result storage unit 380.

Note that, in determining whether or not each block is a block belonging to the invalid area, the invalid area determination unit 2110 first acquires the recognition result from a CNN unit 320 and specifies a quantization value when the precise recognition result was not output. Subsequently, the invalid area determination unit 2110 determines whether or not each block is a block belonging to the invalid area, based on whether or not the difference between the aggregated value corresponding to the minimum quantization value and the aggregated value at the specified quantization value is equal to or greater than a predetermined threshold value.

In addition, the invalid area determination unit 2110 notifies the invalidated image generation unit 2120 of the block determined to belong to the invalid area.

The invalidated image generation unit 2120 generates invalidated image data in which the block notified by the invalid area determination unit 2110, among the respective blocks included in the image data, is invalidated. Furthermore, the invalidated image generation unit 2120 notifies an output unit 340 of the generated invalidated image data.

### <Specific Example of Processing by Invalid Area Determination Unit>

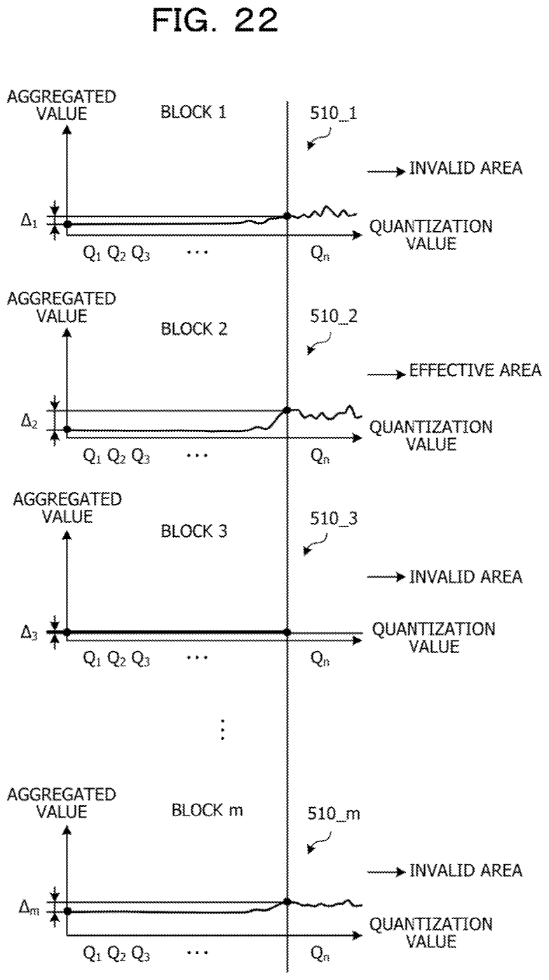

Next, a specific example of processing by the invalid area determination unit 2110 will be described. FIG. 22 is a diagram illustrating a specific example of processing by the invalid area determination unit. In FIG. 22, graphs 510_1 to 510_m are the same as the graphs 510_1 to 510_m illustrated in FIG. 5. However, in the graphs 510_1 to 510_m illustrated in FIG. 22, the quantization values (unrecognizable quantization values) when the precise recognition result was not output in the recognition process by the CNN unit 320 are clearly indicated (refer to the dashed-dotted line).

The invalid area determination unit 2110 calculates the difference between the aggregated value corresponding to the minimum quantization value and the aggregated value corresponding to the unrecognizable quantization value. The example in FIG. 22 illustrates that the differences calculated in the blocks 1 to m are Δ₁ to Δₘ, respectively.

The invalid area determination unit 2110 determines whether or not the corresponding block is a block belonging to the invalid area, based on whether or not the calculated difference is equal to or greater than a predetermined threshold value.

The example in FIG. 22 illustrates a state in which the invalid area determination unit 2110 determines that the block 1 is a block belonging to the invalid area because Δ₁ is less than the predetermined threshold value. On the other hand, the example in FIG. 22 illustrates a state in which the invalid area determination unit 2110 determines that the block 2 is a block belonging to the effective area because Δ₂ is equal to or greater than the predetermined threshold value. In addition, the example in FIG. 22 illustrates a state in which the invalid area determination unit 2110 determines that the block 3 is a block belonging to the invalid area because Δ₃ is less than the predetermined threshold value.

### <Specific Example of Invalidated Image Data>

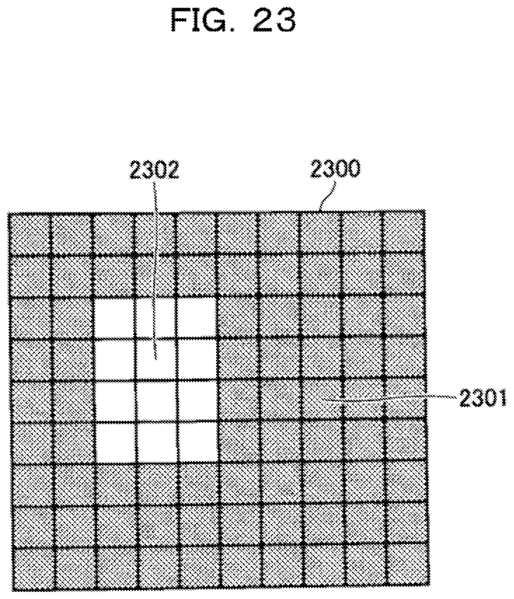

Next, a specific example of the invalidated image data generated by the invalidated image generation unit 2120 will be described. FIG. 23 is a diagram illustrating a specific example of the invalidated image data.

In invalidated image data 2300 illustrated in FIG. 23, a hatched area 2301 is an area determined to be an invalid area by the invalid area determination unit 2110. On the other hand, in the invalidated image data 2300, a non-hatched area 2302 is an area determined to be an effective area by the invalid area determination unit 2110.

The output unit 340 invalidates each block included in the area 2301 and transmits image data (invalidated image data 2300) made up of the respective blocks included in the area 2302 to an image compression device 130.

This causes the image compression device 130 to generate the compressed data by performing the compression process on the invalidated image data 2300. Therefore, the data size of the compressed data may be further reduced as compared with the case where the compression process is performed on the entire image data using the optimum quantization value.

Note that, when the image compression device 130 performs the compression process on the invalidated image data 2300, an analysis device 120 may calculate an optimum quantization value according to the degree of influence on the recognition result for each block included in the area 2302 and may transmit the calculated optimum quantization value to the image compression device 130.

Consequently, the data size of the compressed data may be still further reduced as compared with the case where the compression process is performed on the invalidated image data 2300 using a quantization value assigned in advance.

### <Flow of Image Compression Process by Compression Processing System>

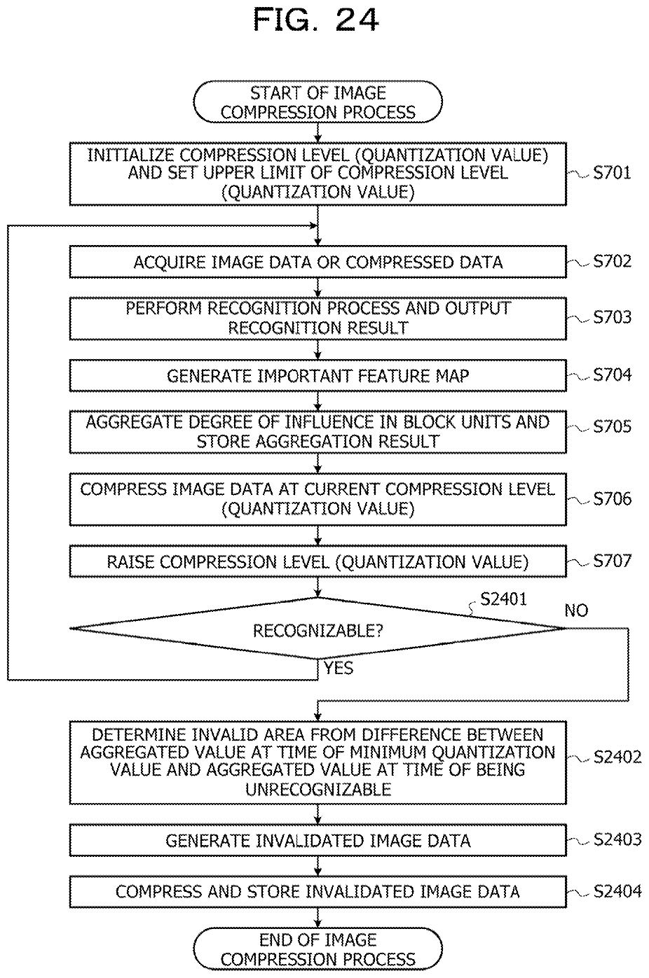

Next, a flow of an image compression process by a compression processing system 100 will be described. FIG. 24 is a seventh flowchart illustrating an example of the flow of the image compression process by the compression processing system. The differences from the first flowchart illustrated in FIG. 7 are steps S2401 to S2404.

In step S2401, the invalid area determination unit 2110 determines whether or not a precise recognition result has been output from the CNN unit 320. When it is determined in step S2401 that a precise recognition result has been output (in the case of Yes in step S2401), the process returns to step S702.

On the other hand, when it is determined in step S2401 that a precise recognition result has not been output (in the case of No in step S2401), the process proceeds to step S2402.

In step S2402, the invalid area determination unit 2110 calculates the difference between the aggregated value associated with the minimum quantization value and the aggregated value associated with the quantization value at the time of being unrecognizable, for each block. In addition, the invalid area determination unit 2110 determines whether or not each block is a block belonging to the invalid area, based on the calculated difference.

In step S2403, the invalidated image generation unit 2120 generates the invalidated image data by invalidating the block belonging to the invalid area.

In step S2404, the output unit 340 transmits the invalidated image data to the image compression device 130. In addition, the image compression device 130 performs the compression process on the invalidated image data and stores the compressed data in a storage device 140. Note that the image compression device 130 performs the compression process using the quantization value when the precise recognition result was output immediately before it is determined that the precise recognition result was not output.

As is clear from the above description, the analysis device according to the seventh embodiment acquires each piece of compressed data when the compression process is performed on the image data using different quantization values. In addition, the analysis device according to the seventh embodiment generates the important feature map indicating the degree of influence on the recognition result, based on the CNN unit structure information when the recognition process was performed by inputting the decoded data obtained by decoding each piece of the compressed data to the learned model and aggregates the degree of influence for each block. Furthermore, the analysis device according to the seventh embodiment determines whether or not each block belongs to the invalid area, based on the difference between the aggregated value corresponding to the quantization value when the precise recognition result was not output and the aggregated value corresponding to the minimum quantization value. Moreover, the analysis device according to the seventh embodiment performs the compression process on the invalidated image data in which the block belonging to the invalid area is invalidated.

In this manner, by performing the compression process on the image data in which the invalid area determined based on the degree of influence on the recognition result is invalidated, an effect similar to the effect of the first embodiment described above is obtained, and additionally, the data size of the compressed data may be further reduced as compared with the first embodiment described above.

### Eighth Embodiment

In the seventh embodiment described above, the block belonging to the invalid area has been described as being determined based on the degree of influence on the recognition result. In contrast to this, in the eighth embodiment, the block belonging to the effective area is determined based on the degree of influence on the recognition result.

Note that, in the eighth embodiment, in determining the block belonging to the effective area, the minimal effective area is first set, and the effective area is fixed by gradually expanding the effective area according to changes in the aggregated value of each block when the quantization value is raised. In this manner, in the eighth embodiment, a decrease in recognition accuracy due to raising the quantization value is covered by the expansion of the effective area, whereby a larger quantization value may be designated as the optimum quantization value. The eighth embodiment will be described below focusing on differences from the seventh embodiment described above.

### <Functional Configuration of Analysis Device>

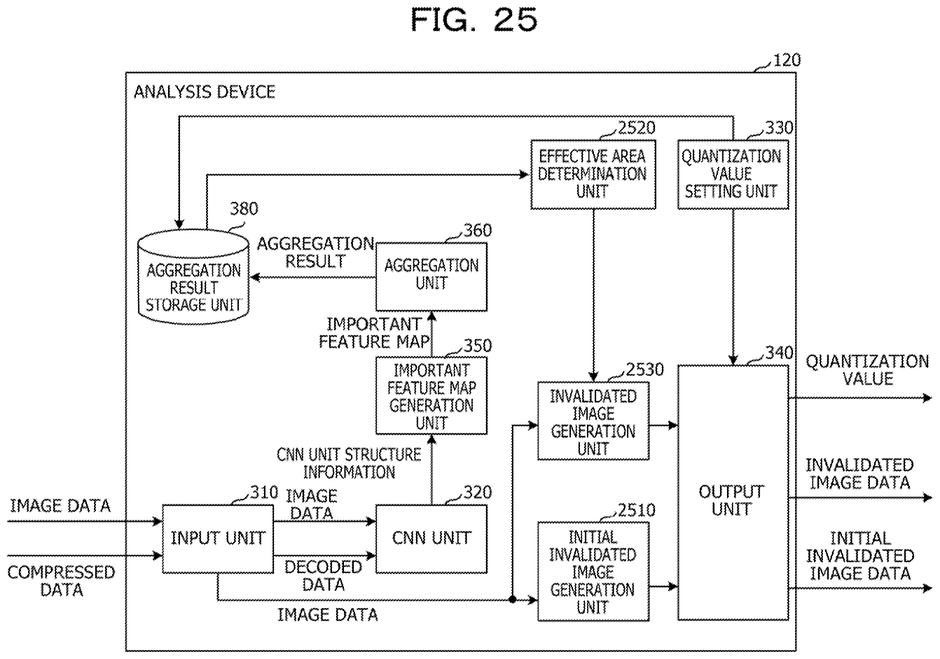

First, a functional configuration of an analysis device 120 according to the eighth embodiment will be described. FIG. 25 is a sixth diagram illustrating an example of the functional configuration of the analysis device. The differences from the functional configuration illustrated in FIG. 21 are that an initial invalidated image generation unit 2510 is included, and an effective area determination unit 2520 is included instead of the invalid area determination unit 2110. In addition, the function of an invalidated image generation unit 2530 is different from the function of the invalidated image generation unit 2120 in FIG. 21.

The initial invalidated image generation unit 2510 generates invalidated image data including a preset minimal effective area (referred to as initial invalidated image data). In addition, the initial invalidated image generation unit 2510 notifies an output unit 340 of the generated initial invalidated image data.

The effective area determination unit 2520 reads the aggregation result from an aggregation result storage unit 380 and determines whether or not the effective area is to be expanded, based on the amount of change in the aggregated value of each block with respect to the change in the quantization value. In addition, when it is determined that the effective area is to be expanded, the effective area determination unit 2520 notifies the invalidated image generation unit 2530 of the expanded effective area.

The invalidated image generation unit 2530 invalidates the blocks belonging to the area (invalid area) other than the expanded effective area notified by the effective area determination unit 2520 and generates the invalidated image data. In addition, the invalidated image generation unit 2530 notifies the output unit 340 of the generated invalidated image data.

### <Specific Example of Processing by Effective Area Determination Unit>

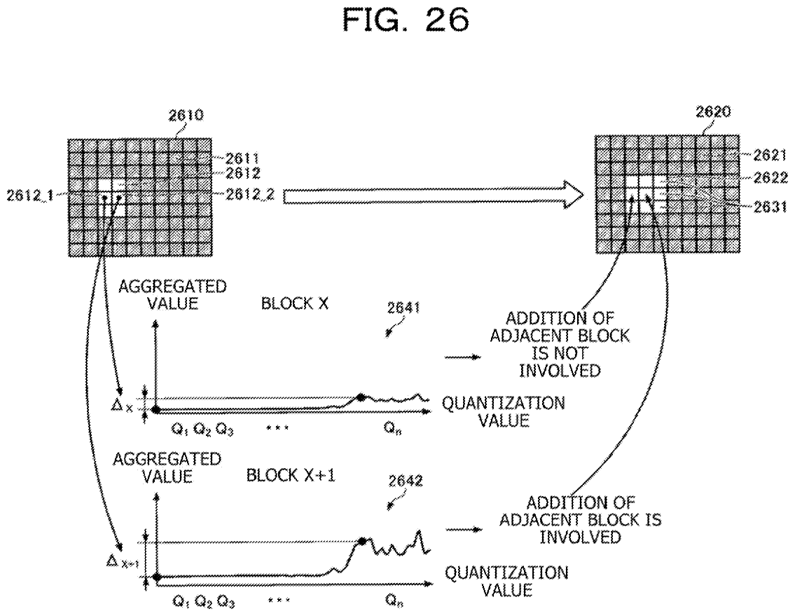

Next, a specific example of processing by the effective area determination unit 2520 will be described. FIG. 26 is a diagram illustrating a specific example of processing by an effective area determination unit. In FIG. 26, initial invalidated image data 2610 indicates initial invalidated image data generated by the initial invalidated image generation unit 2510.

In the initial invalidated image data 2610, the hatched area is an invalid area 2611. On the other hand, in the initial invalidated image data 2610, a non-hatched area 2612 is the minimal effective area.

Here, an image compression device 130 performs the compression process on the initial invalidated image data 2610 based on different quantization values. This causes a CNN unit 320 to perform the recognition process on the decoded data obtained by decoding the compressed data corresponding to each quantization value and causes an aggregation unit 360 to aggregate the degree of influence on the recognition result corresponding to each quantization value in block units.

In FIG. 26, a graph 2641 indicates the aggregated values of a block 2612_1 (the block number=“block X”) corresponding to each quantization value. In addition, a graph 2642 indicates the aggregated values of a block 2612_2 (the block number=“block X+1”) corresponding to each quantization value.

The effective area determination unit 2520 calculates a difference Δₓ between the aggregated value corresponding to the current quantization value and the aggregated value corresponding to the minimum quantization value for the block 2612_1, for example. This causes the effective area determination unit 2520 to determine whether or not the effective area is desired to be expanded to a block adjacent to the block 2612_1.

Similarly, the effective area determination unit 2520 calculates a difference Δₓ₊₁ between the aggregated value corresponding to the current quantization value and the aggregated value corresponding to the minimum quantization value for the block 2612_2. This causes the effective area determination unit 2520 to determine whether or not the effective area is desired to be expanded to a block adjacent to the block 2612_2.

Note that the effective area determination unit 2520 makes a similar determination for all the blocks located inside the boundary position between the effective area and the invalid area.

The example in FIG. 26 illustrates a state in which it is determined for the block 2612_1 that the effective area does not have to be expanded to an adjacent block because Δₓ is less than a predetermined threshold value. In addition, the example in FIG. 26 illustrates a state in which it is determined for the block 2612_2 that the effective area has to be expanded to an adjacent block because Δₓ₊₁ is equal to or greater than a predetermined threshold value.

Note that the effective area determination unit 2520 notifies the invalidated image generation unit 2530 of the expanded effective area in which a block adjacent to the block 2612_2 is included into the effective area, and the invalidated image generation unit 2530 generates the invalidated image data based on the notified expanded effective area.

In FIG. 26, invalidated image data 2620 indicates the invalidated image data generated by the invalidated image generation unit 2530 based on the expanded effective area notified by the effective area determination unit 2520.

As illustrated in FIG. 26, an effective area 2622 of the invalidated image data 2620 includes blocks 2631 adjacent to the block 2612_2. In addition, an invalid area 2621 of the invalidated image data 2620 has become smaller than the invalid area 2611 of the initial invalidated image data 2610 because the effective area has been expanded.

In this manner, the effective area determination unit 2520 fixes the effective area by gradually expanding the effective area according to the change in the aggregated value of each block when the quantization value is raised. Note that, when the aggregated value of a block located inside the boundary position between the effective area and the invalid area is lowered by including an adjacent block into the effective area, and the difference with the aggregated value corresponding to the minimum quantization value becomes less than the predetermined threshold value, the effective area determination unit 2520 continues the expansion of the effective area.

On the other hand, when the aggregated value of a block located inside the boundary position between the effective area and the invalid area is not lowered although an adjacent block is included into the effective area, and the difference with the aggregated value corresponding to the minimum quantization value remains equal to or greater than the predetermined threshold value, the effective area determination unit 2520 terminates the expansion of the effective area.

### <Flow of Image Compression Process by Compression Processing System>

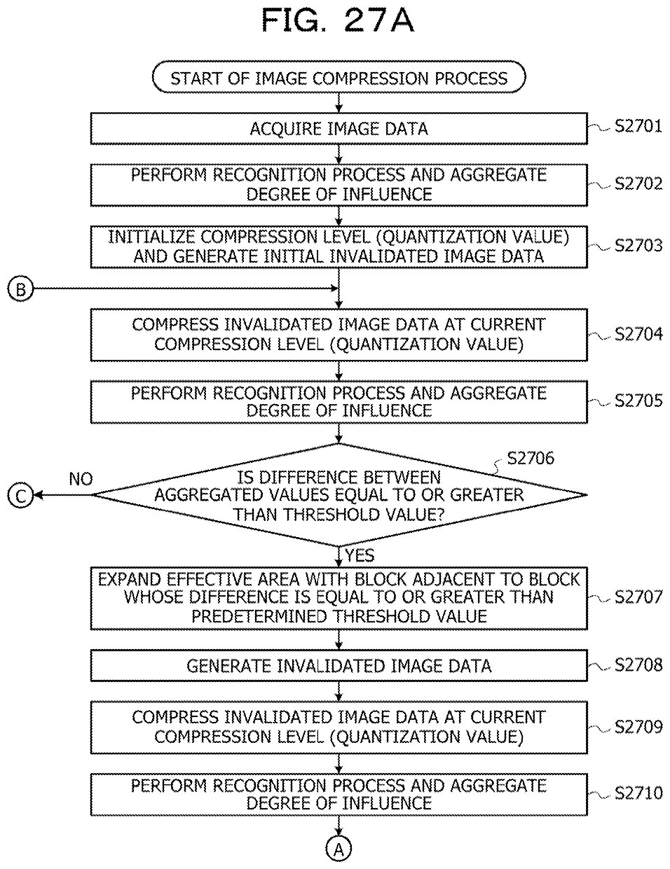

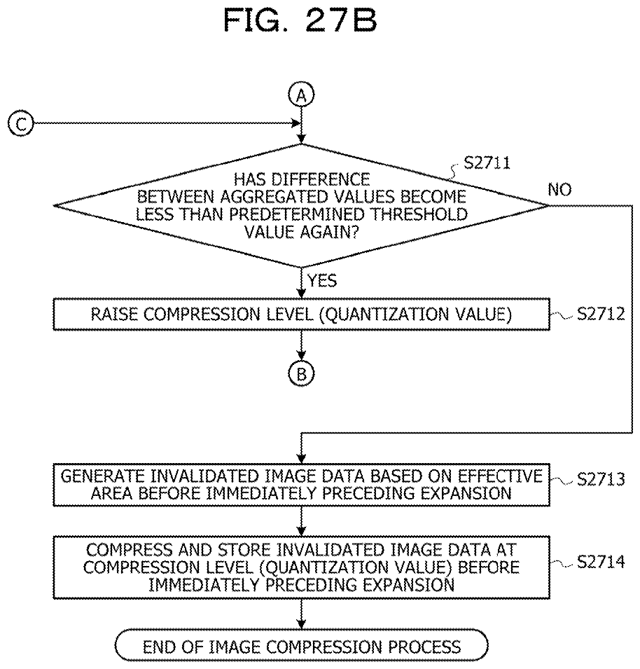

Next, a flow of an image compression process by a compression processing system 100 will be described. FIGS. 27A and 27B are an eighth flowchart illustrating an example of the flow of the image compression process by the compression processing system.

In step S2701, an input unit 310 acquires image data in frame units.

In step S2702, the CNN unit 320 performs the recognition process on the image data to output the recognition result, and an important feature map generation unit 350 generates the important feature map. In addition, the aggregation unit 360 aggregates the degree of influence in block units. Consequently, the aggregated value corresponding to the minimum quantization value is calculated for each block.

In step S2703, a quantization value setting unit 330 initializes the compression level and additionally, sets the upper limit of the compression level. In addition, the initial invalidated image generation unit 2510 generates the initial invalidated image data.

In step S2704, the image compression device 130 performs the compression process on the invalidated image data (here, the initial invalidated image data) using the current quantization value and generates the compressed data.

In step S2705, the CNN unit 320 performs the recognition process on the decoded data obtained by decoding the compressed data to output the recognition result, and the important feature map generation unit 350 generates the important feature map. In addition, the aggregation unit 360 aggregates the degree of influence in block units.

In step S2706, for the block inside the boundary position between the effective area and the invalid area, the effective area determination unit 2520 determines whether or not the difference between the aggregated value corresponding to the current quantization value and the aggregated value corresponding to the minimum quantization value is equal to or greater than a predetermined threshold value.

When it is determined in step S2706 that the difference is less than the predetermined threshold value (in the case of No in step S2706), the process proceeds to step S2712.

On the other hand, when it is determined in step S2706 that the difference is equal to or greater than the predetermined threshold value (in the case of Yes in step S2706), the process proceeds to step S2707.

In step S2707, the effective area determination unit 2520 includes a block adjacent to the block whose difference is equal to or greater than the predetermined threshold value, into the effective area and notifies the invalidated image generation unit 2530 of the expanded effective area.

In step S2708, the invalidated image generation unit 2530 generates the invalidated image data based on the expanded effective area.

In step S2709, the image compression device 130 performs the compression process on the invalidated image data using the current quantization value and generates the compressed data.

In step S2710, the CNN unit 320 performs the recognition process on the decoded data obtained by decoding the compressed data to output the recognition result, and the important feature map generation unit 350 generates the important feature map. In addition, the aggregation unit 360 aggregates the degree of influence in block units.

In step S2711, the effective area determination unit 2520 determines whether or not the aggregated value has been lowered and the difference has become less than the predetermined threshold value for the block determined to be equal to or greater than the predetermined threshold value in step S2706.

When it is determined in step S2711 that the difference has become less than the predetermined threshold value (in the case of Yes in step S2711), the process proceeds to step S2712.

In step S2712, the quantization value setting unit 330 raises the compression level (quantization value), and the process returns to step S2704.

On the other hand, when it is determined in step S2711 that the difference remains equal to or greater than the predetermined threshold value (in the case of No in step S2711), the process proceeds to step S2713.

In step S2713, the invalidated image generation unit 2530 generates the invalidated image data based on the effective area immediately before the effective area is expanded in step S2707.

In step S2714, the image compression device 130 performs the compression process on the invalidated image data generated in step S2713, using the compression level (quantization value) immediately before the effective area is expanded in step S2707 and stores the compressed data.

As is clear from the above description, the analysis device according to the eighth embodiment first sets the minimal effective area and gradually expands the effective area according to changes in the aggregated value of each block when the quantization value is raised.

Consequently, according to the analysis device according to the eighth embodiment, a decrease in recognition accuracy due to raising the quantization value may be covered by the expansion of the effective area, and the compression process may be performed with a larger quantization value as the optimum quantization value.

As a result, according to the eighth embodiment, an effect similar to the effect of the first embodiment described above may be obtained, and additionally, the data size of the compressed data may be further reduced than the first embodiment described above.

### Ninth Embodiment

In the eighth embodiment described above, in expanding the effective area, attention is paid to the aggregated value of the block inside the boundary position between the effective area and the invalid area. In contrast to this, in a ninth embodiment, in expanding the effective area, attention is paid to the aggregated values of blocks adjacent with the boundary position interposed (the aggregated value of the block inside and the aggregated value of the block outside the boundary position between the effective area and the invalid area). The ninth embodiment will be described below focusing on differences from the eighth embodiment described above.

### <Functional Configuration of Analysis Device>

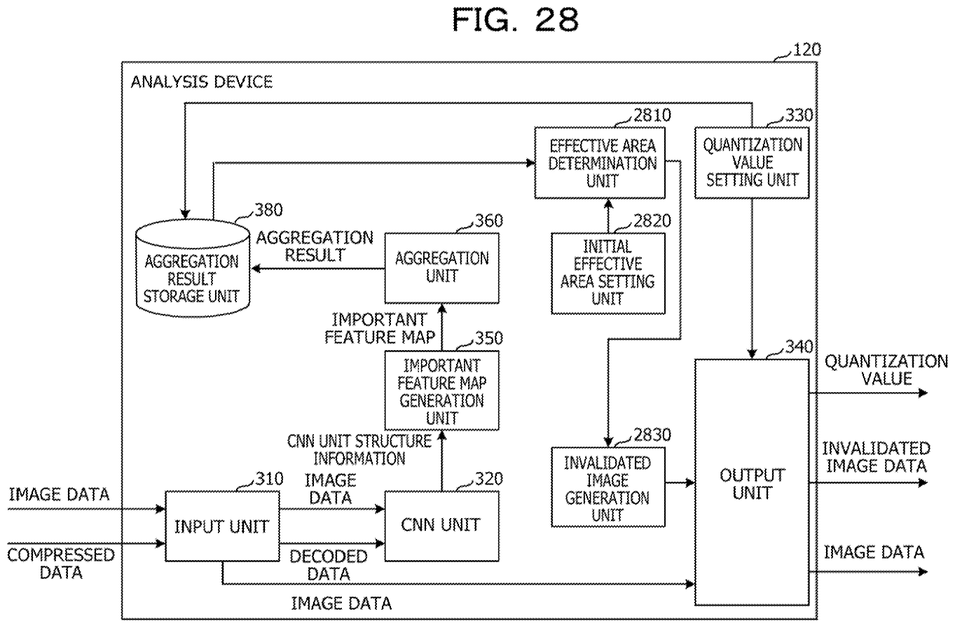

First, a functional configuration of an analysis device 120 according to the eighth embodiment will be described. FIG. 28 is a seventh diagram illustrating an example of the functional configuration of the analysis device.

The differences from the functional configuration illustrated in FIG. 25 is that the function of an effective area determination unit 2810 is different from the function of the effective area determination unit 2520, and the function of an invalidated image generation unit 2830 is different from the function of the invalidated image generation unit 2530. In addition, an initial effective area setting unit 2820 is included instead of the initial invalidated image generation unit 2510.

The initial effective area setting unit 2820 first sets a minimal effective area in the effective area determination unit 2810.

The effective area determination unit 2810 reads the aggregation result from an aggregation result storage unit 380 and determines whether or not the effective area is to be expanded, based on the aggregated value of each block at each quantization value.

For example, the effective area determination unit 2810 acquires the aggregated value of each block when the aggregated value of each block is calculated for each piece of compressed data generated each time the quantization value is raised for the entire image data and is stored in the aggregation result storage unit 380.

At that time, the effective area determination unit 2810 calculates the difference in the aggregated values between the block located inside and the block located outside the boundary position between the initial effective area and the invalid area (between blocks adjacent with the boundary position interposed). Then, when it is determined that the calculated difference is equal to or greater than a predetermined threshold value, the effective area determination unit 2810 includes the block located outside the boundary position into the effective area.

Also after that, the aggregated value of each block is similarly acquired for each piece of compressed data generated each time the quantization value is raised continuously for the entire image data. At that time, the effective area determination unit 2810 calculates the difference in the aggregated values between the block located inside and the block located outside the boundary position between the expanded effective area and the invalid area. Then, when it is determined that the calculated difference is equal to or greater than the predetermined threshold value, the effective area determination unit 2810 includes the block located outside the boundary position into the effective area.

The invalidated image generation unit 2830 generates the invalidated image data based on the effective area when the expansion of the effective area by the effective area determination unit 2810 is completed. In addition, the invalidated image generation unit 2830 notifies an output unit 340 of the generated invalidated image data.

### <Specific Example of Processing by Effective Area Determination Unit>

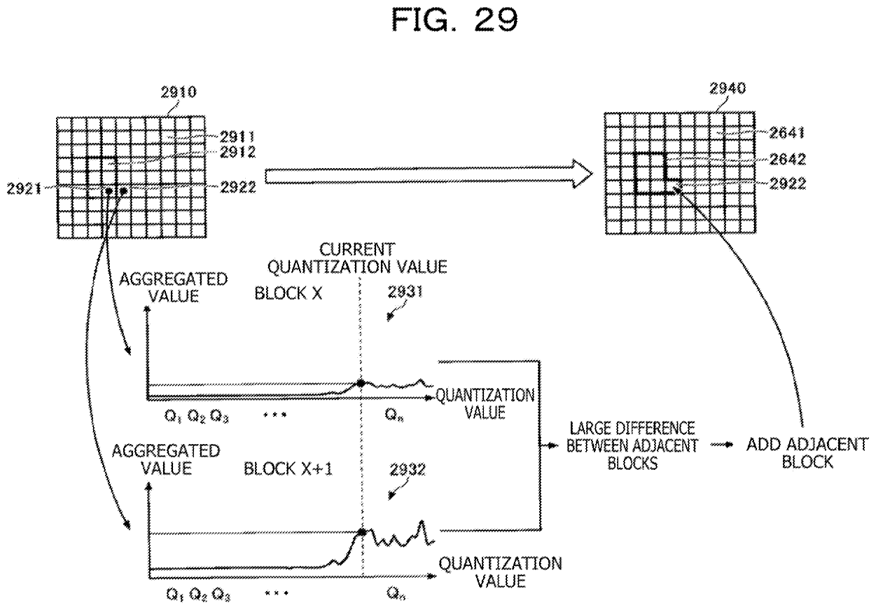

Next, a specific example of processing by the effective area determination unit 2810 will be described. FIG. 29 is a second diagram illustrating a specific example of processing by the effective area determination unit. In FIG. 29, image data 2910 is image data on which the compression process is to be performed by an image compression device 130. In addition, an initial effective area 2912 in the image data 2910 indicates an initial effective area set by the initial effective area setting unit 2820.

Here, the image compression device 130 performs the compression process on the image data 2910 using each quantization value to generate the compressed data. This causes a CNN unit 320 to perform the recognition process on the decoded data obtained by decoding the compressed data corresponding to each quantization value and causes an aggregation unit 360 to aggregate the degree of influence on the recognition result corresponding to each quantization value in block units.

In FIG. 29, a graph 2931 indicates the aggregated values of a block 2921 (the block number=“block X”) corresponding to each quantization value. Note that the block 2921 is a block inside the boundary position between the initial effective area 2912 and an invalid area 2911.

In addition, a graph 2932 indicates the aggregated values of a block 2922 (the block number=“block X+1”) corresponding to each quantization value. Note that the block 2922 is a block outside the boundary position between the initial effective area 2912 and the invalid area 2911 and is a block adjacent to the block 2921.

The effective area determination unit 2810 calculates the difference between the aggregated value of the block 2921 and the aggregated value of the block 2922 corresponding to the current quantization value and determines whether or not the block 2922 is to be included into the effective area by determining whether or not the calculated difference is equal to or greater than a predetermined threshold value.

The example in FIG. 29 illustrates a state in which the block 2922 is determined to be included into the effective area. Note that the effective area determination unit 2810 performs a similar process on all the blocks located inside the boundary position between the initial effective area and the invalid area.

In FIG. 29, image data 2940 indicates a state in which an expanded effective area 2942 is set by the effective area determination unit 2810. In FIG. 29, the block 2922 is a block newly included into the effective area.

Note that, also after that, the image compression device 130 similarly acquires the aggregated value of each block for each piece of compressed data generated each time the quantization value is raised continuously for the entire image data. At that time, the effective area determination unit 2810 calculates the difference in the aggregated values between the block located inside and the block located outside the boundary position between the expanded effective area 2942 and an invalid area 2941. Then, when it is determined that the calculated difference is equal to or greater than the predetermined threshold value, the effective area determination unit 2810 includes the block located outside the boundary position into the effective area.

When the expansion of the effective area is completed, the effective area determination unit 2810 notifies the invalidated image generation unit 2830 of the effective area at the time of completion, and the invalidated image generation unit 2830 generates the invalidated image data based on the notified effective area.

### <Flow of Image Compression Process by Compression Processing System>

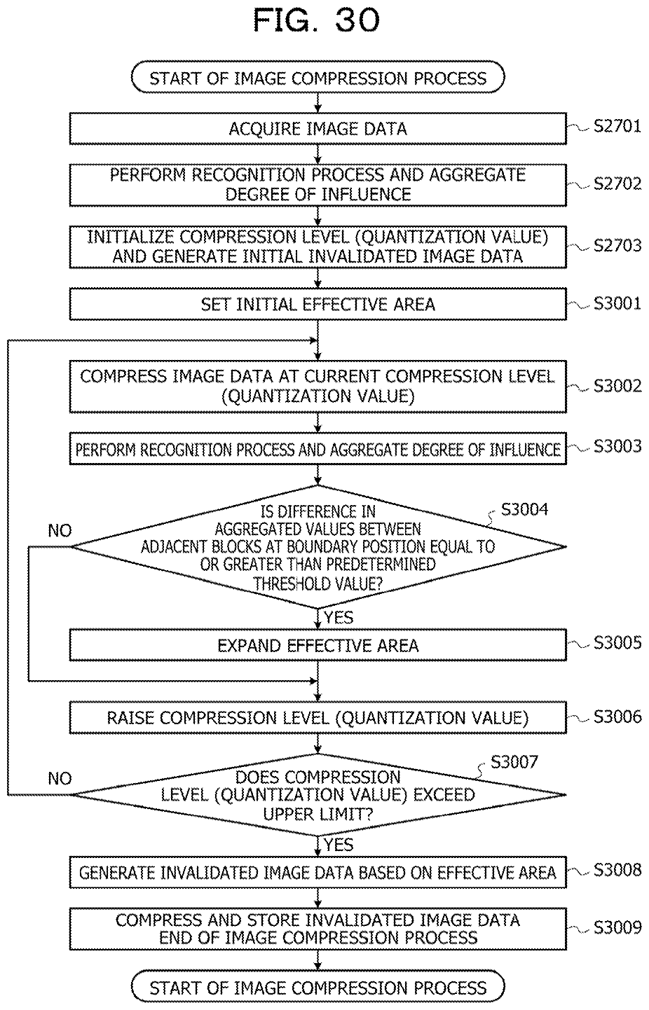

Next, a flow of an image compression process by a compression processing system 100 will be described. FIG. 30 is a ninth flowchart illustrating an example of the flow of the image compression process by the compression processing system. The differences from the eighth flowchart illustrated in FIGS. 27A and 27B are steps S3001 to S3009.

In step S3001, the initial effective area setting unit 2820 sets the initial effective area.

In step S3002, the image compression device 130 performs the compression process on the image data with the current quantization value and generates the compressed data.

In step S3003, the CNN unit 320 performs the recognition process on the decoded data obtained by decoding the compressed data to output the recognition result, and the important feature map generation unit 350 generates the important feature map. In addition, an aggregation unit 360 aggregates the degree of influence in block units.

In step S3004, the effective area determination unit 2810 calculates the difference in the aggregated values between the block inside and the block outside the boundary position for the current effective area and invalid area and determines whether or not the calculated difference in the aggregated values is equal to or greater than a predetermined threshold value.

When it is determined in step S3004 that the difference is less than the predetermined threshold value (in the case of No in step S3004), the process proceeds to step S3006.

On the other hand, when it is determined in step S3004 that the difference is equal to or greater than the predetermined threshold value (in the case of Yes in step S3004), the process proceeds to step S3005.

In step S3005, the effective area determination unit 2810 includes the block outside the boundary position into the effective area.

In step S3006, a quantization value setting unit 330 raises the compression level (quantization value), and the process proceeds to step S3007.

In step S3007, the quantization value setting unit 330 determines whether or not the compression level (quantization value) exceeds the upper limit and, when it is determined that the upper limit is not exceeded (in the case of No in step S3007), the process returns to step S3002.

On the other hand, when it is determined in step S3007 that the upper limit is exceeded (in the case of Yes in step S3007), the process proceeds to step S3008.

In step S3008, the invalidated image generation unit 2830 generates the invalidated image data based on the current effective area.

In step S3009, the image compression device 130 performs the compression process on the invalidated image data and stores the compressed data. Note that the image compression device 130 performs the compression process on the invalidated image data using, for example, the quantization value when the effective area is expanded.

As is clear from the above description, the analysis device according to the ninth embodiment first sets the minimal effective area and gradually expands the effective area according to the difference in the aggregated values between adjacent blocks at the boundary position when the quantization value is raised.

Consequently, according to the analysis device according to the ninth embodiment, a decrease in recognition accuracy due to raising the quantization value may be covered by the expansion of the effective area, and the compression process may be performed with a larger quantization value as the optimum quantization value.

As a result, according to the ninth embodiment, an effect similar to the effect of the first embodiment described above may be obtained, and additionally, the data size of the compressed data may be further reduced than the first embodiment described above.

### Other Embodiments

In the first embodiment described above, the compression process has been described as being performed all using the minimum quantization value to the maximum quantization value. However, the quantization values used for the compression process are not limited to this, and the compression process may be performed using a predetermined number of quantization values included between the minimum quantization value and the maximum quantization value. The predetermined number of quantization values refers to a number of quantization values that allow the optimum quantization value to be designated and refers to at least two or more quantization values.

In addition, in the first embodiment described above, the image data has been described as including one object. However, the image data may include a plurality of objects. In this case, the CNN unit structure information may be acquired simultaneously for the plurality of objects in the image data, and the compression levels may be designated simultaneously for the plurality of objects. Alternatively, after the CNN unit structure information is acquired separately for the plurality of objects in the image data and the compression levels are designated for each object, the compression level of the entire image data may be designated by merging the compression level of each object.

In addition, in the third embodiment described above, as the image processing when the pseudo-compressed data is generated, the filtering process using a low-pass filter has been described as an example. However, the image processing when the pseudo-compressed data is generated is not limited to this.

For example, the Fourier transform may be performed on the entire image data, and the inverse Fourier transform may be performed after high-frequency components are cut. Alternatively, the Fourier transform may be performed on the image data in block units, and the inverse Fourier transform may be performed after high-frequency components are cut.

Alternatively, the entire image data may be transformed by the discrete cosine transform (DCT) and transformed by the inverse DCT after quantization. Alternatively, the image data may be transformed by the DCT in block units and transformed by the inverse DCT after quantization.

In addition, in any of the seventh to ninth embodiments described above or an embodiment combining any of the seventh to ninth embodiments described above, an area having a large degree of influence on the recognition result and an area having a small degree of influence on the recognition result may be separated such that
any of the first to sixth embodiments described above or an embodiment combining any of the first to sixth embodiments described above is applied to the area having a large degree of influence on the recognition result, and
a quantization value for high compression is applied to (or the invalid area is formed by) the area having a small degree of influence on the recognition result.

Note that the compression level calculated in each of the above embodiments and the information indicating the effective area or the invalid area may be used as information for designating the processing content of preprocessing for image data in which the reduction of the data size can be expected by performing the compression process. For example, the preprocessing mentioned here includes a process of reducing color information from image data, a process of reducing high-frequency components from the image data, and the like.

Note that the embodiments are not limited to the configurations described here and may include combinations of the configurations or the like described in the above embodiments with other elements, and the like. These points can be altered without departing from the spirit of the embodiments and can be appropriately assigned according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An analysis device comprising:
a memory; and
a computer coupled to the memory and configured to:
store information that indicates a degree of influence of each area of each piece of decoded data on recognition results and is calculated by performing a recognition process on the decoded data obtained by decoding each piece of compressed data when a compression process is performed on image data at different compression levels; and
designate the compression levels for each area of the image data, based on the information that corresponds to the different compression levels and indicates the degree of influence of each area of each piece of the decoded data on the recognition results.

2. The analysis device according to claim 1, wherein the processor:
generates a map that indicates the degree of influence of each area of the decoded data on the recognition results and is calculated by performing the recognition process on the decoded data;
aggregates the degree of influence of each area of the decoded data on the recognition results, in block units used when the compression process is performed, based on the generated map; and
stores aggregated values aggregated in the block units, as the information that indicates the degree of influence of each area on the recognition results.

3. The analysis device according to claim 1, wherein the processor:
stores group information in which the compression levels are associated with respective groups when the information that indicates the degree of influence of each area of each piece of the decoded data on the recognition results and corresponds to the different compression levels is classified into a plurality of groups; and
determines which of the respective groups the information that indicates the degree of influence of each area on the recognition results and corresponds to a predetermined one of the compression levels belongs to, and designates one of the compression levels associated with a determined group, as the compression levels for each area of the image data.

4. The analysis device according to claim 3, wherein the processor:
determines which of the respective groups the information that indicates the degree of influence of each area of pseudo-compressed data generated by performing image processing on the image data, on the recognition results and is calculated by performing the recognition process on the pseudo-compressed data belongs to, and designates the one of the compression levels associated with the determined group, as the compression levels for each area of the image data.

5. The analysis device according to claim 1, wherein the processor:
designates the compression levels for each area of different pieces of the image data such that the information that indicates the degree of influence of each area of each piece of the decoded data on the recognition results and is calculated by performing the recognition process on the decoded data obtained by decoding each piece of the compressed data when the compression process is performed on the different pieces of the image data at the different compression levels does not exceed a predetermined threshold value.

6. The analysis device according to claim 2, wherein the processor:
compares the aggregated values of a reference block and the aggregated values of another block, among the aggregated values aggregated in the block units that are predetermined, and designates the compression levels of the another block, based on the compression levels of the reference block and comparison results.

7. The analysis device according to claim 1, wherein the processor:
designates the compression levels for each area of the image data by multiplying the information that indicates the degree of influence of each area of the decoded data on the recognition results for a precise recognition result, which was output immediately before an erroneous recognition result was output, by a weighting factor, and adding the multiplied information to preset compression levels.

8. The analysis device according to claim 1, wherein the processor:
acquires the information that indicates the degree of influence of each area of the decoded data on the recognition results for a precise recognition result, which was output immediately before an erroneous recognition result was output, and determines an invalid area; and
generates invalidated image data by invalidating an area determined to be the invalid area in the image data.

9. The analysis device according to claim 2, wherein the processor:
generates invalidated image data by invalidating an invalid area that is predetermined in the image data;
stores the aggregated values of respective blocks included in an effective area of each piece of the invalidated image data, which are calculated by performing the recognition process on the decoded data obtained by decoding each piece of the compressed data when the compression process is performed on the invalidated image data at the different compression levels; and
generates new invalidated image data in which the effective area is expanded, when the aggregated values of blocks located inside a boundary position between the effective area and the invalid area satisfies a predetermined condition, among the aggregated values of the respective blocks included in the effective area of the invalidated image data.

10. The analysis device according to claim 2, wherein the processor:
determines an effective area in the image data;
generates invalidated image data by invalidating an invalid area other than the determined effective area in the image data;
stores the aggregated values of respective blocks of each piece of the decoded data calculated by performing the recognition process on the decoded data obtained by decoding each piece of the compressed data when the compression process is performed on the image data at the different compression levels;
expands the effective area, when the aggregated values of blocks adjacent with a boundary position between the effective area and the invalid area interposed satisfy a predetermined condition, among the aggregated values of the respective blocks of the decoded data; and
generates the invalidated image data by invalidating the invalid area other than the expanded effective area in which the effective area is expanded.

11. An analysis method comprising:
storing, by a computer, information that indicates a degree of influence of each area of each piece of decoded data on recognition results and is calculated by performing a recognition process on the decoded data obtained by decoding each piece of compressed data when a compression process is performed on image data at different compression levels; and
designating the compression levels for each area of the image data, based on the information that corresponds to the different compression levels and indicates the degree of influence of each area of each piece of the decoded data on the recognition results.
